(19) United States
(12) Patent Application Publication
(10) Pub. No.: US 2007/0021303 A1
(43) Pub. Date: Jan. 25, 2007

(54) Safening method

(76) Inventors: Christopher Rosinger, Hofheim (DE); Jan Van Den Berg, Heythuysen (NL); Bart Geraats, Weert (NL)

Correspondence Address: FROMMER LAWRENCE & HAUG, 745 FIFTH AVENUE- 10TH FL., NEW YORK, NY, 10151, US

(21) Appl. No.: 11/183,661

(22) Filed: Jul. 18, 2005

(30) Foreign Application Priority Data
Jul. 20, 2004 (DE) 10 2004 035 136.8

(51) Int. Cl. A01N 25/32

(52) U.S. Cl. 504/105

(57) ABSTRACT

The invention relates to the sue of a compound (B) as safener for reducing or avoiding phytotoxic side-effects of a pesticide (A) in useful plants selected from the plant order Liliiflorae, wherein (A) is one or more pesticides, and (B) is one or more safeners selected from the group consisting of safeners (B1) to (B19) as defined in claim 1. The safener can be applied by various methods including spraying techniques and seed treatment.

The invention relates to the technical field of crop protection compositions and safening of crops against phytotoxic effects of pesticides, in particular safening of crops of some useful plants selected from a specific plant order against pesticides which are highly suitable for use against harmful organisms in said crops.

The application of pesticides such as herbicides and also fungicides and insecticides against harmful organisms in crops of useful plants is often limited by phytotoxic effects of the pesticides in said crops. As a result the application of the particular pesticide in said crop is not possible at all or possible only at an application rate where the desired effect against harmful organisms is insufficient.

For example, it is known that many herbicides injure crop plants at herbicide application rates needed to control weed growth. This renders many herbicides unsuitable for controlling weeds in the presence of certain crops. Where weed growth in crops is uncontrolled however, this results in lower crop yield and reduced crop quality, as weeds will compete with crops for nutrients, light and water. Reduction in herbicidal injury to crops without an unacceptable reduction in the herbicidal action can be accomplished by use of crop protectants known as “safeners”, also sometimes referred to as “antidotes” or “antagonists”. The safening effect of a compound is generally more or less specific to the herbicidal partner and the crop where the active ingredients are applied.

Likewise some crops can be protected by specific safeners or antidots which are able to reduce or avoid the phytotoxicity of other pesticides such as fungicides or pesticides against harmful animals, such as insecticides, acaricides, nematicides, molluscicides or miticides (in short together also called just “insecticides”) towards the crops without reducing or substantially reducing the desired effect of the pesticides against harmful organisms.

Various commercial safeners have been developed for major cereal crops including maize, mainly for safening the crops against damage of herbicides. The use of safeners against damage of pesticides in other culture crops such as vegetable crops is relatively rare.

We have now shown that, surprisingly, some crop plants selected from useful plants of the order Liliiflorae can be effectively protected against undesirable damage by pesticides if the pesticides are applied together with certain compounds acting as safeners to the crop plants.

Accordingly, the present invention provides a use of a compound (B) as safener for reducing or avoiding phytotoxic side-effects of a pesticide (A) in useful plants selected from the plant order Liliiflorae, wherein
(A) is one or more pesticides, preferably selected from herbicides, insecticides and fungicides, or agriculturally acceptable salts thereof, and
(B) is one or more safeners selected from the group consisting of (abbreviation “PM” used herein means “The Pesticide Manual”, 13th edition):
(B1) compounds of the dichlorophenylpyrazoline-3-carboxylic acid type, preferably compounds such as ethyl 1-(2,4-dichlorophenyl)-5-(ethoxycarbonyl)-5-methyl-2-pyrazoline-3-carboxylate (B1-1) (“Mefenpyr-diethyl”, PM, pp. 622-623) and related compounds as they are described in WO 91/07874;
(B2) dichlorophenylpyrazolecarboxylic acid derivatives, preferably compounds such as ethyl 1-(2,4-dichlorophenyl)-5-methylpyrazole-3-carboxylate (B2-1), ethyl 1-(2,4-dichlorophenyl)-5-isopropylpyrazole-3-carboxylate (B2-2), ethyl 1-(2,4-dichlorophenyl)-5-(1,1-dimethylethyl)pyrazole-3-carboxylate (B2-3), ethyl 1-(2,4-dichlorophenyl)-5-phenylpyrazole-3-carboxylate (B2-4) and related compounds as they are described in EP-A-333 131 and EP-A-269 806;
(B3) compounds of the triazolecarboxylic acids type, preferably compounds such as fenchlorazol and its ethyl ester, i.e. ethyl 1-(2,4-dichlorophenyl)-5-trichloromethyl-(1H)-1,2,4-triazole-3-carboxylate (B3-1), and related compounds (see EP-A-174 562 and EP-A-346 620);
(B4) compounds of the 5-benzyl- or 5-phenyl-2-isoxazoline-3-carboxylic acid type or the 5,5-diphenyl-2-isoxazoline-3-carboxylic acid, preferably compounds such as ethyl 5-(2,4-dichlorobenzyl)-2-isoxazoline-3-carboxylate (B4-1) or ethyl 5-phenyl-2-isoxazoline-3-carboxylate (B4-2) and related compounds as they are described in WO 91/08202, or ethyl 5,5-diphenyl-2-isoxazoline-3-carboxylate (B4-3) (“isoxadifen-ethyl”, PM, p. 588) or n-propyl 5,5-diphenyl-2-isoxazoline-3-carboxylate (B4-4) or ethyl 5-(4-fluorophenyl)-5-phenyl-2-isoxazoline-3-carboxylate (B4-5), as they are described in German Patent Application (WO-A-95/07897);
(B5) compounds of the 8-quinolinoxyacetic acid type, preferably 1-methylhex-1-yl (5-chloro-8-quinolinoxy)acetate (common name “cloquintocet-mexyl”) (B5-1) (see PM, pp. 196-197)
1,3-dimethylbut-1-yl(5-chloro-8-quinolinoxy)acetate (B5-2),
4-allyloxybutyl(5-chloro-8-quinolinoxy)acetate (B5-3),
1-allyloxyprop-2-yl(5-chloro-8-quinolinoxy)acetate (B5-4),
ethyl(5-chloro-8-quinolinoxy)acetate (B5-5),
methyl(5-chloro-8-quinolinoxy)acetate (B5-6),
allyl(5-chloro-8-quinolinoxy)acetate (B5-7),
2-(2-propylideneiminooxy)-1-ethyl(5-chloro-8-quinolinoxy)acetate (B5-8),
2-oxoprop-1-yl(5-chloro-8-quinolinoxy)acetate (B5-9),
   and related compounds as are described in EP-A-86 750, EP-A-94 349 and EP-A-191 736 or EP-A-0 492 366;
(B6) compounds of the (5-chloro-8-quinolinoxy)malonic acid type, preferably compounds such as diethyl(5-chloro-8-quinolinoxy)malonate, diallyl (5-chloro-8-quinolinoxy)malonate, methylethyl(5-chloro-8-quinolinoxy)malonate and related compounds as are described in EP-A-0 582 198;
(B7) active substances of the phenoxyacetic or phenoxypropionic acid derivatives type or of the aromatic carboxylic acids type, such as, for example,
2,4-dichlorophenoxyacetic acids (and its esters) (2,4-D),
4-chloro-2-methylphenoxypropionic esters (mecoprop), MCPA or
3,6-dichloro-2-methoxybenzoic acid (and its esters) (dicamba);
(B8) active substances of the pyrimidines type which are employed in rice as soil-acting safeners, such as, for example,
“fenclorim” (PM, pp. 406) (=4,6-dichloro-2-phenylpyrimidine),
(B9) active substances of the dichloroacetamides type, such as
“dichlormid” (PM, pp. 284) (═N,N-diallyl-2,2-dichloroacetamide),
“R-29148” (=3-dichloroacetyl-2,2,5-trimethyl-1,3-oxazolidine, by Stauffer),
“benoxacor” (PM, pp. 72-73) (=4-dichloroacetyl-3,4-dihydro-3-methyl-2H-1,4-benzoxazine) (B9-1),
“PPG-1292” (═N-allyl-N-[(1,3-dioxolan-2-yl)methyl]dichloroacetamide by PPG Industries),
“DK-24” (═N-allyl-N-[(allylaminocarbonyl)methyl]dichloroacetamide by Sagro-Chem),
“AD-67” or “MON 4660” (=3-dichloroacetyl-1-oxa-3-azaspiro[4,5]decane by Nitrokemia and Monsanto, respectively),
“diclonon” or “BAS145138” or “LAB145138” (=3-dichloroacetyl-2,5,5-trimethyl-1,3-diazabicyclo[4.3.0]nonane by BASF) and
“furilazol” or “MON 13900” (see PM, 507) (=(RS)-3-dichloroacetyl-5-(2-furyl)-2,2-dimethyloxazolidine);
(B10) active substances of the dichloroacetone derivatives type, such as, for example,
“MG 191” (CAS Reg. No. 96420-72-3) (=2-dichloromethyl-2-methyl-1,3-dioxolane by Nitrokemia),
(B11) active substances of the oxyimino compounds type, such as, for example,
“oxabetrinil” (PM, pp. 724-725) (=(Z)-1,3-dioxolan-2-ylmethoxyimino(phenyl)-acetonitrile) (B11-1),
“fluxofenim” (PM, pp. 490) (=1-(4-chlorophenyl)-2,2,2-trifluoro-1-ethanone O-(1,3-dioxolan-2-ylmethyl)oxime (B11-2), and
“cyometrinil” or “-CGA-43089” (PM, p. 1056) (=(Z)-cyanomethoxy-imino(phenyl)acetonitrile),
(B12) active substances of the thiazolecarboxylic ester type, for example,
“flurazole” (PM, pp. 473-474) (=benzyl 2-chloro-4-trifluoromethyl-1,3-thiazole-5-carboxylate),
(B13) active substances of the naphthalenedicarboxylic acid derivatives type, such as, for example,
“naphthalic anhydride” (PM, p. 1083) (=1,8-naphthalenedicarboxylic anhydride) (B13-1),
(B14) active substances of the chromanacetic acid derivatives type, such as, for example,
“CL 304415” (CAS Reg. No. 31541-57-8) (=2-(4-carboxychroman-4-yl)acetic acid by American Cyanamid),
(B15) active substances which, in addition to a herbicidal action against harmful plants, also exhibit a safener action in connection with crop plants for example,
“dimepiperate” or “MY-93” (PM, pp. 316-317) (═S-1-methyl-1-phenylethyl piperidine-1-carbothioate),
“daimuron” or “SK 23” (PM, p. 259) (=1-(1-methyl-1-phenylethyl)-3-p-tolylurea),
“cumyluron”=“JC-940” (=3-(2-chlorophenylmethyl)-1-(1-methyl-1-phenyl-ethyl)urea, see JP-A-60087254),
“methoxyphenone” or “NK 049” (=3,3′-dimethyl-4-methoxybenzophenone), “CSB” (=1-bromo-4-(chloromethylsulfonyl)benzene) (CAS Reg. No. 54091-06-4, by Kumiai),
(B16) N-acylsulfonamides of the formula (S3) and their salts 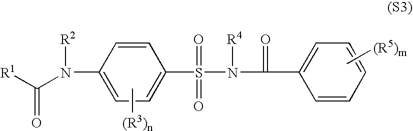
   as are described in WO-A-97/45016;
(B17) acylsulfamoylbenzamides of the formula (S4), if appropriate also in salt form, 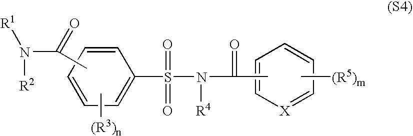
   as are described in WO-A-99/16744);
(B18) dietholate (no ISO common name, approved by the Weed Society of America), i.e. O,O-diethyl O-phenyl phosphorothioate, and
(B19) mephenate (no ISO common name, approved by the Weed Society of America), i.e 4-chlorophenyl methyl carbamate,
   including the stereoisomers and the salts conventionally used in agriculture.

Amongst the safeners mentioned, those which are of particular interest are (B1-1), (B4-3), (B5-1), (B13-1) and safeners of the group (B17). Also of interest are (B9-1), (B11-1) and (B11-2).

Preference is given to herbicide-safener combinations comprising one or more compounds (A) and an effective amount of one or more compounds (B) selected from the group consisting of:
(B1.1) compounds of the phenylpyrazolin-3-carboxylic acid type, for example of the formula (I): 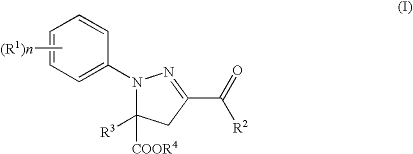
   in which
R¹ are identical or different and are halogen, (C₁-C₄)-alkyl, (C₁-C₄)-alkoxy, nitro or (C₁-C₄)-haloalkyl,
n is an integer from 0 to 5, preferably from 0 to 3,
R² is OR⁵, SR⁶ or NR⁷R⁸ or a saturated or unsaturated 3- to 7-membered heterocycle having at least one nitrogen atom and up to 3 heteroatoms, preferably selected from the group consisting of O and S, which is attached to the carbonyl group in formula (I) via the nitrogen atom and which is unsubstituted or substituted by radicals selected from the group consisting of (C₁-C₄)-alkyl, (C₁-C₄)-alkoxy and unsubstituted or substituted phenyl, preferably a radical of the formula OR⁵, NHR⁷ or N(CH3)2, in particular of the formula OR⁵,
R³ is hydrogen, (C₁-C₈)-alkyl, (C₁-C₈)-haloalkyl, (C₃-C₁₂)-cycloalkyl or substituted or unsubstituted phenyl,
R⁴ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkyl-silyl,
R⁵, R⁶, R⁷ independently of one another are hydrogen or an unsubstituted or substituted aliphatic hydrocarbon radical, preferably having a total of 1 to 18 carbon atoms, and
R⁸ is hydrogen, (C₁-C₆)-alkyl, (C₁-C₆)-alkoxy or substituted or unsubstituted phenyl,
   preferably compounds such as ethyl 1-(2,4-dichlorophenyl)-5-(ethoxycarbonyl)-5-methyl-2-pyrazoline-3-carboxylate (B1-1) (“Mefenpyr-diethyl”, see “The Pesticide Manual”, 13th edition 2003, pp. 622-623), and related compounds as described in WO 91/07874,
   (“The Pesticide Manual”, 13th edition, is hereinbelow also abbreviated “PM”),
(B3.1) compounds of the triazolecarboxylic acid type, for example of the formula (III): 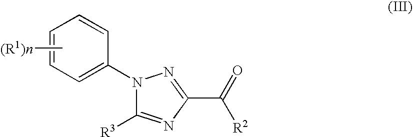
   in which
R¹, n, R² and R³ are as defined under formula (I),
   preferably fenchlorazole(ethyl ester), i.e. ethyl 1-(2,4-dichlorophenyl)-5-trichloromethyl-(1H)-1,2,4-triazole-3-carboxylate (B3-1) and related compounds as described in EP-A-174 562 and EP-A-346 620,
(B4.1) compounds of the 5-benzyl-, 5-phenyl- or 5,5-diphenyl-2-isoxazoline-3-carboxylic acid type, for example of the formula (IV): 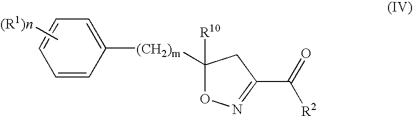
   in which
R¹, n and R² are as defined under formula (I) and R¹⁰ is hydrogen, (C₁-C₈)-alkyl, (C₁-C₈)-haloalkyl, (C₃-C₁₂)-cycloalkyl or substituted or unsubstituted phenyl and
m is 0 or 1,
   preferably compounds such as
ethyl 5-(2,4-dichlorobenzyl)-2-isoxazoline-3-carboxylate or ethyl 5-phenyl-2-isoxazoline-3-carboxylate (B1.4.2) and related compounds as described in WO 91/08202, or
ethyl 5,5-diphenyl-2-isoxazolinecarboxylate (B4-3) (“isoxadifen-ethyl”) or the n-propyl ester or
ethyl 5-(4-fluorophenyl)-5-phenyl-2-isoxazoline-3-carboxylate as described in WO-A-95/07897,
(B5) compounds of the 8-quinolinoxyacetic acid type, preferably 1-methylhex-1-yl (5-chloro-8-quinolinoxy)acetate (common name “cloquintocet-mexyl”) (B5-1) (see PM, pp. 196-197)
1,3-dimethylbut-1-yl(5-chloro-8-quinolinoxy)acetate (B5-2),
4-allyloxybutyl(5-chloro-8-quinolinoxy)acetate (B5-3),
1-allyloxyprop-2-yl(5-chloro-8-quinolinoxy)acetate (B5-4),
ethyl(5-chloro-8-quinolinoxy)acetate (B5-5),
methyl(5-chloro-8-quinolinoxy)acetate (B5-6),
allyl(5-chloro-8-quinolinoxy)acetate (B5-7),
2-(2-propylideneiminooxy)-1-ethyl(5-chloro-8-quinolinoxy)acetate (B5-8),
2-oxoprop-1-yl(5-chloro-8-quinolinoxy)acetate (B5-9),
   and related compounds as are described in EP-A-86 750, EP-A-94 349 and EP-A-191 736 or EP-A-0 492 366;
(B12) active compounds of the thiazolecarboxylic esters type which are known as seed dressings, such as, for example, “flurazole” (PM, pp. 450-451) (=benzyl 2-chloro-4-trifluoromethyl-1,3-thiazole-5-carboxylate), which is known as a seed-dressing safener for millet against alachlor and metolachlor damage,
(B13) active substances of the naphthalenedicarboxylic acid derivatives type, such as, for example,
“naphthalic anhydride” (PM, p. 1083) (=1,8-naphthalenedicarboxylic anhydride) (B13-1),
(B16) N′-acyl-N-benzoyl-aminobenzolsulfonamides of the formula (V) and their salts: 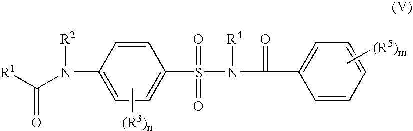
   as described in WO-A-97/45016, in which
R¹ is hydrogen, a hydrocarbon radical, a hydrocarbon-oxy radical, a hydrocarbon-thio radical or a heterocyclyl radical, which is preferably attached via a carbon atom, where each of the 4 last-mentioned radicals is unsubstituted or substituted by one or more identical or different radicals selected from the group consisting of halogen, cyano, nitro, amino, hydroxyl, carboxyl, formyl, carboxamide, sulfonamide and radicals of the formula Z^{a}-R^{a},
where each hydrocarbon moiety has preferably 1 to 20 carbon atoms and a carbon-containing radical R¹, including substituents, has preferably 1 to 30 carbon atoms,
R² is hydrogen or (C₁-C₄)-alkyl, preferably hydrogen, or
R¹ and R² together with the group of the formula —CO—N— are the radical of a 3- to 8-membered saturated or unsaturated ring,
R³ are identical or different and are halogen, cyano, nitro, amino, hydroxyl, carboxyl, formyl, CONH₂, SO₂NH₂ or a radical of the formula Z^{b}-R^{b},
R⁴ is hydrogen or (C₁-C₄)-alkyl, preferably hydrogen,
R⁵ are identical or different and are halogen, cyano, nitro, amino, hydroxyl, carboxyl, CHO, CONH₂, SO₂NH₂ or a radical of the formula Z^{c}-R^{c},
R^{a} is a hydrocarbon radical or a heterocyclyl radical, where each of the two last-mentioned radicals is unsubstituted or substituted by one or more identical or different radicals selected from the group consisting of halogen, cyano, nitro, amino, hydroxyl, mono- and di-[(C₁-C₄)-alkyl]amino, or an alkyl radical in which a plurality, preferably 2 or 3, of non-adjacent CH₂ groups are in each case replaced by an oxygen atom,
R^{b},R^{c} are identical or different and are a hydrocarbon radical or a heterocyclyl radical, where each of the two last-mentioned radicals is unsubstituted or substituted by one or more identical or different radicals selected from the group consisting of halogen, cyano, nitro, amino, hydroxyl, phosphoryl, halo-(C₁-C₄)-alkoxy, mono- and di-[(C₁-C₄)-alkyl]amino, or an alkyl radical in which a plurality, preferably 2 or 3, of non-adjacent CH₂ groups are in each replaced by an oxygen atom,
Z^{a} is a divalent group of the formula O, S, CO, CS, CO—O, CO—S, O—CO, S—CO, SO, SO₂, NR*, CO—NR*, NR*—CO, SO₂—NR* or NR*—SO₂, where the bond indicated on the right-hand side of the divalent group in question is the bond to the radical R^{a} and where the radicals R* in the 5 last-mentioned radicals independently of one another are in each case H, (C₁-C₄)-alkyl or halo-(C₁-C₄)-alkyl,
Z^{b},Z^{c} independently of one another are a direct bond or a divalent group of the formula O, S, CO, CS, CO—O, CO—S, O—CO, S—CO, SO, SO₂, NR*, SO₂—NR*, NR*—SO₂, CO—NR* or NR*—CO, where in the case of assymetrical divalent groups the atom located on the right-hand side is attached to the radical R^{b} or R^{c}, and where the radicals R* in the 5 last-mentioned radicals independently of one another are in each case H, (C₁-C₄)-alkyl or halo-(C₁-C₄)-alkyl,
n is an integer from 0 to 4, preferably 0, 1 or 2, in particular 0 or 1, and
m is an integer from 0 to 5, preferably 0, 1, 2 or 3, in particular 0, 1 or 2,
   for example the compound 1-(4-(N-2-methoxybenzoylsulfamoyl)phenyl)-3-methylurea, i.e. formula (V) in which R═CH₃NH—, R²═H, n=0, R⁴═H and (R⁵)ₘ=2-methoxy (B3.1.1),
(B17) acylsulfamoylbenzamides of the formula (VI), if appropriate also in salt form, 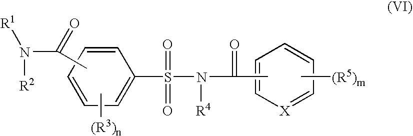
   as described in the International Application No. PCT/EP98/06097 (WO-A-99/16744), in which
X is CH or N,
R¹ is hydrogen, heterocyclyl or a hydrocarbon radical, where the two last-mentioned radicals are unsubstituted or substituted by one or more identical or different radicals selected from the group consisting of halogen, cyano, nitro, amino, hydroxyl, carboxyl, CHO, CONH₂, SO₂NH₂ and Z^{d}-R^{d},
R² is hydrogen, hydroxyl, (C₁-C₆)-alkyl, (C₂-C₆)-alkenyl, (C₂-C₆)-alkynyl, (C₁-C₆)-alkoxy, (C₂-C₆)-alkenyloxy, where the five last-mentioned radicals are unsubstituted or substituted by one or more identical or different radicals selected from the group consisting of halogen, hydroxyl, (C₁-C₄)-alkyl, (C₁-C₄)-alkoxy and (C₁-C₄)-alkylthio, or
R¹ and R² together with the nitrogen atom that carries them are a 3- to 8-membered saturated or unsaturated ring,
R³ are identical or different and are halogen, cyano, nitro, amino, hydroxyl, carboxyl, CHO, CONH₂, SO₂NH₂ or Z^{e}-R^{e},
R⁴ is hydrogen, (C₁-C₄)-alkyl, (C₂-C₄)-alkenyl or (C₂-C₄)-alkynyl,
R⁵ are identical or different and are halogen, cyano, nitro, amino, hydroxyl, carboxyl, phosphoryl, CHO, CONH₂, SO₂NH₂ or Z^{f}-R^{f},
R^{d} is a (C₂-C₂₀)-alkyl radical whose carbon chain is interrupted once or a plurality of times by oxygen atoms, is heterocyclyl or a hydrocarbon radical, where the two last-mentioned radicals are unsubstituted or substituted by one or more identical or different radicals selected from the group consisting of halogen, cyano, nitro, amino, hydroxy, mono- and di-[(C₁-C₄)-alkyl]amino;
R^{e}, R^{f} are identical or different and are a (C₂-C₂₀)-alkyl radical whose carbon chain is interrupted once or a plurality of times by oxgen atoms, or are heterocyclyl or a hydrocarbon radical, where the two last-mentioned radicals are unsubstituted or substituted by one or more identical or different radicals selected from the group consisting of halogen, cyano, nitro, amino, hydroxyl, phosphoryl, (C₁-C₄)-haloalkoxy, mono- and di-[(C₁-C₄)-alkyl]amino,
Z^{d} is a divalent unit selected from the group consisting of O, S, CO, CS, C(O)O, C(O)S, SO, SO₂, NR*, C(O)NR* or SO₂NR*,
Z^{e}, Z^{f} are identical or different and are a direct bond or a divalent unit selected from the group consisting of O, S, CO, CS, C(O)O, C(O)S, SO, SO₂, NR*, SO₂NR* or C(O)NR*,
R* is hydrogen, (C₁-C₄)-alkyl or (C₁-C₄)-haloalkyl,
n is an integer from 0 to 4, and
m is, in the case that X is CH, an integer from 0 to 5 and, in the case that X is N, an integer from 0 to 4,
   for example the compound 4-(2-methoxybenzoylsulfamoyl)-N-cyclopropylbenzamide (B17-1), and
   including the stereoisomers and the agriculturally useful salts thereof.

Also preferred are safeners from the groups:
(B9) active substances of the dichloroacetamides type, such as
“benoxacor” (PM, pp. 72-73) (=4-dichloroacetyl-3,4-dihydro-3-methyl-2H-1,4-benzoxazine) (B9-1), and
(B11) active substances of the oxyimino compounds type, such as, for example,
“oxabetrinil” (PM, pp. 724-725) (=(Z)-1,3-dioxolan-2-ylmethoxyimino(phenyl)-acetonitrile) (B11-1),
“fluxofenim” (PM, pp. 490) (=1-(4-chlorophenyl)-2,2,2-trifluoro-1-ethanone O-(1,3-dioxolan-2-ylmethyl)oxime (B11-2), and
“cyometrinil” or “-CGA-43089” (PM, p. 1056) (=(Z)-cyanomethoxy-imino(phenyl)acetonitrile),

Some of the safeners are already known as herbicides or pesticides and therefore simultaneously display a protective action in connection with the crop plants in addition to the herbicidal action or pesticidal action in connection with harmful plants or other harmful organisms, respectively.

The safeners (B) used in the combinations of the present invention are understood to embrace all stereoisomers and mixtures thereof, as well as their salts.

The advantageous safener effects are observed when the active compounds (A) and (B) are applied simultaneously, however, they can also frequently be observed when the active compounds are applied at different times (splitting). It is also possible to apply the active compounds in a plurality of portions (sequential application), for example after pre-emergence applications, followed by post-emergence applications or after early post-emergence applications, followed by medium or late post-emergence applications. It is also possible to use the safeners as a dressing or coating for pre-treating the seeds of the crop plants or plant seedlings. In case of some pesticides such as insecticides or fungicides the pre-treatment of seeds with safener can be combined with the pre-treatment with such a pesticide.

The active compounds of the combination in question are preferably supplied jointly or within a short interval. Preferred is also the seed dressing of the crop plant seeds with compound (B) and later application of compound (A), or treatment of the seeds with a combination of (B) and compounds (A) selected from fungicides and insecticides.

The pesticide-safener combinations reduce or eliminate phytotoxic effects which can occur when the pesticidally active compounds (A) are used in useful plants, without having any substantial detrimental effect on the activity of these active compounds against harmful organisms. They permit a higher dosage (application rate) of the pesticide compared to the individual application of the pesticide in crops of useful plants, and thus a more effective control of the harmful organisms, e.g. competing harmful plants. In case of a herbicide as a pesticide the higher efficacy permits the control of weed species which are as yet uncontrolled (gaps), an extension of the period of application and/or a reduction in the number of individual applications required and
as a result for the user—weed control systems which are more advantageous economically and ecologically.

It has hitherto not been known and is also surprising that the phytotoxicity of the pesticides (A) at said type of monocotyledonous plants can be reduced effectively or eliminated with the aid of safeners (B). In general, said plants are much different in the biological response to the application of pesticides compared with commercially important cereal plants. Thus, an effect of the safeners in combination with pesticides on such plants would not have been predicted in a similar fashion.

The safeners together with pesticides are suitable for the selective control of harmful organisms in a number of useful plants selected from monocotyledonous plants of the plant order Liliiflorae, for example the plant families Liliaceae, Amaryllidaceae, Iridaceae and Juncadeae, preferably plants of the plant family Liliaceae, such as monocotyledonous vegetables, ornamentals and flowers of said plant family, such as plants from the genera Tofieldia, Narthecium, Veratrum, Colchicum, Anthericum, Hemerocallis, Gagea, Allium, Lilium, Fritillaria, Tulipa, Lloydia, Scilla, Ornithogalum, Muscari, Asparagus, Ruscus, Maianthemum, Polygonatum, Streptopus, Convallaria, Paris, more preferably plants from the genera Allium or Asparagus. More preferred are crop plants such as leeks (e.g. Allium porrum), onions (e.g. Allium cepa, Allium fistulosum), garlic (Allium sativum), chives (Allium schoenoprasum), shallots (Allium ascalonicum), or asparagus (e.g. Asparagus officinalis). Most preferred are leeks and onions.

Also of interest are mutant crops which are partially tolerant or insufficiently tolerant to some pesticides or transgenic crops which are partially or insufficiently tolerant, for example crops resistant to glufosinate, glyphosate or herbicidal imidazolinones. However, the particular advantage of the novel use of the safeners is their effective action in crops which are normally not sufficiently tolerant to the pesticides mentioned.

For the joint use with pesticides, the compounds of the formula (I) according to the invention can be applied simultaneously with the active compounds or in any order, and they are then capable of reducing or completely eliminating harmful side effects of these active compounds in crop plants, without negatively affecting or substantially reducing the activity of these active compounds against unwanted harmful organisms. Here, even damage caused by using a plurality of pesticides, for example a plurality of herbicides, insecticides or fungicides or herbicides in combination with insecticides or fungicides, can be reduced substantially or eliminated completely. In this manner, it is possible to extend the field of use of conventional pesticides considerably.

If the compositions according to the invention comprise pesticides, these compositions are, after appropriate dilution, applied either directly to the area under cultivation, to the already germinated harmful and/or useful plants or to the already emerged harmful and/or useful plants. If compositions of single formulated compounds (B) are used the compositions according to the invention containing active ingredients (A) and (B) can be prepared by the tank mix method—i.e. the user mixes and dilutes the separately available products (=the pesticide and the agent protecting the useful plants) immediately prior to application to the area to be treated. The application of compound (B) can also be made prior to the application of pesticide (A), or after the application of a pesticide, or used for the pretreatment of seed, i.e., for example, for dressing the seed of the useful plants.

The advantageous actions of the compounds (B) according to the invention are observed when they are used together with the pesticides by the pre-emergence method or the post-emergence method, for example in the case of simultaneous application as a tank mix or a coformulation or in the case of a separate application, in parallel or in succession (split application). It is also possible to repeat the application a number of times. In some cases, it may be expedient to combine a pre-emergence application with a post-emergence application. One option is a post-emergence application of compounds (B) to the useful plant or crop plant together with a simultaneous or later application of the pesticide. Also possible is the use of the compounds (B) according to the invention for seed dressing, for (dip) treatment of seedlings or for the treatment of other propagation material such as plantlets, bulbs, and somatic embryos.

In the seed dressing method the seed can be employed as normal seed or seed which has been pre-treated to enhance growth, such as seed enhanced by steeping, priming or elsewise.

Preferred is the application of the compounds (B) together with the pesticide (A) or prior to the application of pesticide (A). It is also preferred to apply compound (B) by the seed dressing method, optionally combined with an application of an appropriate compound (A) in the seed dressing method.

When using the compounds (B) according to the invention in combination with pesticides, e.g. herbicides, in addition to the safener action, enhanced action, e.g. herbicidal action, against harmful plants is frequently also observed. Furthermore, in many cases, there is an improved growth of the useful plants, and it is possible to increase the harvest yields.

The compositions according to the invention may comprise one or more pesticides. Suitable pesticides are, for example, herbicides, fungicides, pesticides against harmful animals, such as insecticides, acaricides, nematicides, molluscicides and miticides, which, when used on their own, would cause phytotoxic damage to the crop plants or would probably cause damage. Of particular interest are corresponding pesticidally active compounds from the groups of the herbicides, insecticides, acaricides, nematicides, miticides and fungicides, in particular herbicides.

The safeners (B) can be used in the customary manner, separately or together with agrochemicals, e.g. pesticides, fertilizers and/or formulation auxiliaries. Accordingly, the present invention also provides the useful-plant-protecting or crop-plant-protecting compositions.

Herbicides whose phytotoxic side effects on crop plants can be reduced using compounds (B) can be from entirely different structural classes and have entirely different mechanisms of action. Preference is given to commercially available herbicides as described, for example, in the handbook “The Pesticide Manual”, 13th Edition 2003, The British Crop Protection Council (abbreviation herein “PM”), and the e-Pesticide Manual Version 3, The British Crop Protection Council 2003, or else trade names and common names which are referred to in the “Compendium of Pesticide Common Names” (searchable via the Internet) and in literature quoted therein. The herbicides and plant growth regulators mentioned hereinbelow by way of example are in each case referred to by their standardized common active compound name according to the “International Organization for Standardization” (ISO), or by the chemical name or the code number. Examples of active compounds whose phytotoxic action in crop plants and useful plants can be reduced by the compounds (I) according to the invention are:

acetochlor; acifluorfen(-sodium); aclonifen; AKH 7088, i.e. [[[1-[5-[2-chloro-4-(trifluoromethyl)phenoxy]-2-nitrophenyl]-2-methoxyethylidene]amino]oxy]acetic acid and its methyl ester; alachlor; alloxydim(-sodium); ametryn; amicarbazone, amidochlor, amidosulfuron; aminopyralid, amitrol; AMS, i.e. ammonium sulfamate; anilofos; asulam; atrazine; azafenidin; azimsulfuron (DPX-A8947); aziprotryn; barban; BAS 516H, i.e. 5-fluoro-2-phenyl-4H-3,1-benzoxazin-4-one; beflubutamid; benazolin(-ethyl); benfluralin; benfuresate; bensulfuron(-methyl); bensulide; bentazone(-sodium); benzfendizone, benzobicyclone; benzofenap; benzofluor; benzoylprop(-ethyl); benzthiazuron; bialaphos (bilanafos); bifenox; bispyribac(-sodium); bromacil; bromobutide; bromofenoxim; bromoxynil; bromuron; buminafos; busoxinone; butachlor; butafenacil; butamifos; butenachlor; buthidazole; butralin; butroxydim; butylate; cafenstrole (CH-900); carbetamide; carfentrazone(-ethyl); caloxydim, CDAA, i.e. 2-chloro-N,N-di-2-propenylacetamide; CDEC, i.e. 2-chloroallyl diethyldithiocarbamate; chlomethoxyfen; chloramben; chlorazifop-butyl; chlorbromuron; chlorbufam; chlorfenac; chlorfenprop, chlorflurenol-methyl; chloridazon; chlorimuron(-ethyl); chlornitrofen; chlorotoluron; chloroxuron; chlorpropham; chlorsulfuron; chlorthal-dimethyl; chlorthiamid; chlortoluron, cinidon-(-methyl or -ethyl), cinmethylin; cinosulfuron; clethodim; clefoxydim, clodinafop and its ester derivatives (for example clodinafop-propargyl); clomazone; clomeprop; cloprop, cloproxydim; clopyralid; clopyrasulfuron(-methyl); cloransulam(-methyl); cumyluron (JC 940); cyanazine; cycloate; cyclosulfamuron (AC 104); cycloxydim; cycluron; cyhalofop and its ester derivatives (for example butyl ester, DEH-112); cyperquat; cyprazine; cyprazole; daimuron; 2,4-D; 2,4-DB; dalapon; dazomet, desmedipham; desmetryn; di-allate; dicamba; dichlobenil; dichlorprop(-P); diclofop and its esters such as diclofop-methyl; diclosulam, diethatyl(-ethyl); difenoxuron; difenzoquat; diflufenican; diflufenzopyr; dimefuron; dimepiperate; dimethachlor; dimethametryn; dimethenamid (SAN-582H); dimethenamid(-P); dimethazone, dimethipin; dimexyflam, dimetrasulfuron, dinitramine; dinoseb; dinoterb; diphenamid; dipropetryn; diquat; dithiopyr; diuron; DNOC; eglinazine-ethyl; EL 77, i.e. 5-cyano-1-(1,1-dimethylethyl)-N-methyl-1H-pyrazole-4-carboxamide; endothal; epoprodan, EPTC; esprocarb; ethalfluralin; ethametsulfuron-methyl; ethidimuron; ethiozin; ethofumesate; ethoxyfen and its esters (for example ethyl ester, HC-252), ethoxysulfuron, etobenzanid (HW 52); F5231, i.e. N-[2-chloro-4-fluoro-5-[4-(3-fluoropropyl)-4,5-dihydro-5-oxo-1H-tetrazol-1-yl]-phenyl]ethanesulfonamide; fenoprop; fenoxan, fenoxaprop and fenoxaprop-P and their esters, for example fenoxaprop-P-ethyl and fenoxaprop-ethyl; fenoxydim; fentrazamide; fenuron; flamprop(-methyl or -isopropyl or -isopropyl-L); flazasulfuron; florasulam; fluazifop and fluazifop-P and their esters, for example fluazifop-butyl and fluazifop-P-butyl; fluazolate, flucarbazone(-sodium); flucetosulfuron, fluchloralin; flufenacet (FOE 5043), flufenpyr, flumetsulam; flumeturon; flumiclorac(-pentyl); flumioxazin (S482); flumipropyn; fluometuron; fluorochloridone, fluorodifen; fluoroglycofen(-ethyl); flupoxam (KNW-739); flupropacil (UBIC-4243); fluproanate, flupyrsulfuron(-methyl, or -sodium); flurenol(-butyl); fluridone; flurochloridone; fluroxypyr(-meptyl); flurprimidol, flurtamone; fluthiacet(-methyl); fluthiamide (also known as flufenacet); fomesafen; foramsulfuron; fosamine; furilazole (MON 13900), furyloxyfen; glufosinate (-ammonium); glyphosate(-isopropylammonium); halosafen; halosulfuron(-methyl) and its esters (for example the methyl ester, NC-319); haloxyfop and its esters; haloxyfop-P (═R-haloxyfop) and its esters; HC-252 (diphenyl ether), hexazinone; imazamethabenz(-methyl); imazamethapyr; imazamox; imazapic, imazapyr; imazaquin and salts such as the ammonium salts; imazethamethapyr; imazethapyr, imazosulfuron; indanofan; iodosulfuron-(methyl)-(sodium), ioxynil; isocarbamid; isopropalin; isoproturon; isouron; isoxaben; isoxachlortole; isoxaflutole; isoxapyrifop; karbutilate; lactofen; lenacil; linuron; MCPA; MCPA-thioethyl, MCPB; mecoprop(-P); mefenacet; mefluidid; mesosulfuron(-methyl); mesotrione; metam, metamifop, metamitron; metazachlor; methabenzthiazuron; methazole; methoxyphenone; methyldymron; metobenzuron, metobromuron; (S-)metolachlor; metosulam (XRD 511); metoxuron; metribuzin; metsulfuron-methyl; MK-616; molinate; monalide; monocarbamide dihydrogensulfate; monolinuron; monuron; MT 128, i.e. 6-chloro-N-(3-chloro-2-propenyl)-5-methyl-N-phenyl-3-pyridazinamine; MT 5950, i.e. N-[3-chloro-4-(1-methylethyl)-phenyl]-2-methylpentanamide; naproanilide; napropamide; naptalam; NC 310, i.e. 4-(2,4-dichlorobenzoyl)-1-methyl-5-benzyloxypyrazole; neburon; nicosulfuron; nipyraclophen; nitralin; nitrofen; nitrofluorfen; norflurazon; orbencarb; oryzalin; oxadiargyl (RP-020630); oxadiazone; oxasulfuron; oxaziclomefone; oxyfluorfen; paraquat; pebulate; pelargonic acid; pendimethalin; penoxulam; pentanochlor, pentoxazone; perfluidone; pethoxamid, phenisopham; phenmedipham; picloram; picolinafen; pinoxaden, piperophos; piributicarb; pirifenop-butyl; pretilachlor; primisulfuron(-methyl); procarbazone(-sodium); procyazine; prodiamine; profluazole, profluralin; proglinazine(-ethyl); prometon; prometryn; propachlor; propanil; propaquizafop; propazine; propham; propisochlor; propoxycarbazone(-sodium), propyzamide; prosulfalin; prosulfocarb; prosulfuron (CGA-152005); prynachlor; pyraclonil, pyraflufen(-ethyl); pyrazolinate; pyrazon; pyrazosulfuron(-ethyl); pyrazoxyfen; pyribenzoxim; pyributicarb; pyridafol; pyridate; pyriftalid, pyrimidobac(-methyl); pyrithiobac(-sodium) (KIH-2031); pyroxofop and its esters (for example propargyl ester); quinclorac; quinmerac; quinoclamine, quinofop and its ester derivatives, quizalofop and quizalofop-P and their ester derivatives, for example quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]-4,5,6,7-tetrahydro-2H-indazole; secbumeton; sethoxydim; siduron; simazine; simetryn; SN 106279, i.e. 2-[[7-[2-chloro-4-(trifluoromethyl)phenoxy]-2-naphthalenyl]oxy]-propanoic acid and its methyl ester; sulcotrione; sulfentrazone (FMC-97285, F-6285); sulfazuron; sulfometuron(-methyl); sulfosate (ICI-A0224); sulfosulfuron; TCA; tebutam (GCP-5544); tebuthiuron; tepraloxydim; terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide; thiazafluron; thiazopyr (Mon-13200); thidiazimin (SN-24085); thidiazuron, thifensulfuron(-methyl); thiobencarb; tiocarbazil; tralkoxydim; tri-allate; triasulfuron; triaziflam; triazofenamide; tribenuron(-methyl); 2,3,6-trichlorobenzoic acid (2,3,6-TBA), triclopyr; tridiphane; trietazine; trifloxysulfuron(-sodium), trifluralin; triflusulfuron and esters (e.g. methyl ester, DPX-66037); trimeturon; tritosulfuron; tsitodef; vernolate; WL 110547, i.e. 5-phenoxy-1-[3-(trifluoromethyl)phenyl]-1H-tetrazole; UBH-509; D-489; LS 82-556; KPP-300; NC-324; NC-330; KH-218; DPX-N8189; SC-0774; DOWCO-535; DK-8910; V-53482; PP-600; MBH-001; KIH-9201; ET-751; KIH-6127; KIH-2023 and KIH5996.

Herbicides, whose phytotoxic side effects on crop plants can be reduced using compounds of the formula I are, for example, herbicides from the group of the carbamates, thiocarbamates, haloacetanilides, substituted phenoxy-, naphthoxy- and phenoxyphenoxycarboxylic acid derivatives and heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic acid esters, cyclohexanedione oximes, benzoylcyclohexanediones, benzoylisoxazoles, benzoylpyrazoles, imidazolinones, pyrimidinyloxypyridinecarboxylic acid derivatives, pyrimidyloxybenzoic acid derivatives, sulfonylureas, sulfonylaminocarbonyltriazolinones, triazolopyrimidinesulfonamide derivatives, phosphinic acid derivatives and salts thereof, glycine derivatives, triazolinones, triazinones and also S—(N-aryl-N-alkylcarbamoylmethyl)dithiophosphoric esters, pyridinecarboxylic acids, pyridines, pyridinecarboxamides, 1,3,5-triazines, hydroxybenzonitriles, dinitroanilides, ureas, diphenylethers, oxadiazoles, benzamides, bispyridylium derivatives and others.

Herbicides which are suitable for combination with the safeners (B) according to the invention are, for example:
(A1) herbicides of the type of the phenoxyphenoxy- and heteroaryloxyphenoxycarboxylic acid derivatives, such as
(A1.1) phenoxyphenoxy- and benzyloxyphenoxycarboxylic acid derivatives, for example methyl 2-(4-(2,4-dichlorophenoxy)phenoxy)propionate (diclofop-methyl), methyl 2-(4-(4-bromo-2-chlorophenoxy)phenoxy)propionate (DE-A 26 01 548), methyl 2-(4-(4-bromo-2-fluorophenoxy)phenoxy)propionate (U.S. Pat. No. 4,808,750), methyl 2-(4-(2-chloro-4-trifluoromethylphenoxy)phenoxy)propionate (DE-A 24 33 067), methyl 2-(4-(2-fluoro-4-trifluoromethylphenoxy)phenoxy)propionate (U.S. Pat. No. 4,808,750), methyl 2-(4-(2,4-dichlorobenzyl)phenoxy)propionate (DE-A 24 17 487), ethyl 4-(4-(4-trifluoromethylphenoxy)phenoxy)pent-2-enoate, methyl 2-(4-(4-trifluoromethylphenoxy)phenoxy)propionate (DE-A 24 33 067), butyl(R)-2-[4-(4-cyano-2-fluorophenoxy)phenoxy]propionate (cyhalofop-butyl)
(A1.2) “monocyclic” heteroaryloxyphenoxyalkanecarboxylic acid derivatives, for example
ethyl 2-(4-(3,5-dichloropyridyl-2-oxy)phenoxy)propionate (EP-A 0 002 925),
propargyl 2-(4-(3,5-dichloropyridyl-2-oxy)phenoxy)propionate (EP-A 0 003 114),
methyl(RS)- or (R)-2-(4-(3-chloro-5-trifluoromethyl-2-pyridyloxy)phenoxy)propionate (haloxyfop-methyl or haloxyfop-P-methyl),
ethyl 2-(4-(3-chloro-5-trifluoromethyl-2-pyridyloxy)phenoxy)propionate (EP-A 0 003 890),
propargyl 2-(4-(5-chloro-3-fluoro-2-pyridyloxy)phenoxy)propionate (clodinafoppropargyl),
butyl(RS)- or (R)-2-(4-(5-trifluoromethyl-2-pyridyloxy)phenoxy)propionate (fluazifop-butyl or fluazifop-P-butyl),
(R)-2-[4-(3-chloro-5-trifluoromethyl-2-pyridyloxy)phenoxy]propionic acid
(A1.3) “bicyclic” heteroaryloxyphenoxyalkanecarboxylic acid derivatives, for example
methyl and ethyl(RS)- or (R)-2-(4-(6-chloro-2-quinoxalyloxy)phenoxy)propionate (quizalofop-methyl and -ethyl or quizalofop-P-methyl and -P-ethyl),
methyl 2-(4-(6-fluoro-2-quinoxalyloxy)phenoxy)propionate (see J. Pest. Sci. Vol. 10, 61 (1985)),
2-isopropylidenaminooxyethyl(R)-2-(4-(6-chloro-2-quinoxalyloxy)phenoxy)propionate (propaquizafop),
ethyl(RS)- or (R)-2-(4-(6-chlorobenzoxazol-2-yloxy)phenoxy)propionate (fenoxaprop-ethyl or fenoxaprop-P-ethyl),
ethyl 2-(4-(6-chlorobenzthiazol-2-yloxy)phenoxy)propionate (DE-A-26 40 730),
tetrahydro-2-furylmethyl(RS)- or (R)-2-(4-(6-chloroquinoxalyloxy)phenoxy) propionate (EP-A-0 323 727);
(A2) herbicides from the group of the sulfonylureas, such as pyrimidinyl- or triazinylaminocarbonyl[benzene-, -pyridine-, -pyrazole-, -thiophene- and -(alkylsulfonyl)alkylamino]sulfamides. Preferred substituents on the pyrimidine ring or the triazine ring are alkoxy, alkyl, haloalkoxy, haloalkyl, halogen or dimethylamino, it being possible to combine all substituents independently of one another. Preferred substituents in the benzene, pyridine, pyrazole, thiophene or (alkylsulfonyl)alkylamino moiety are alkyl, alkoxy, halogen, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, (alkanesulfonyl)alkylamino. Such suitable sulfonylureas are, for example,
(A2.1) phenyl- and benzylsulfonylureas and related compounds, for example
1-(2-chlorophenylsulfonyl)-3-(4-methoxy-6-methyl-1,3,5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1,3,5-triazin-2-yl)urea (metsulfuron-methyl),
1-(2-chloroethoxyphenylsulfonyl)-3-(4-methoxy-6-methyl-1,3,5-triazin-2-yl)urea (Triasulfuron),
1-(2-Methoxycarbonylphenylsulfonyl)-3-(4,6-dimethylpyrimidin-2-yl)harnstoff (sulfumeturon-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonylbenzylsulfonyl)-3-(4,6-dimethoxypyrimidin-2-yl)urea (bensulfuron-methyl),
1-(2-methoxycarbonylphenylsulfonyl)-3-(4,6-bis-(difluoromethoxy)pyrimidin-2-yl)urea, (primisulfuron-methyl),
3-(4-ethyl-6-methoxy-1,3,5-triazin-2-yl)-1-(2,3-dihydro-1,1-dioxo-2-methylbenzo[b]-thiophene-7-sulfonyl)urea (EP-A 0 079 683),
3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),
3-(4-methoxy-6-methyl-1,3,5-triazin-2-yl)-1-(2-methoxycarbonyl-5-iodophenylsulfonyl)urea (WO 92/13845),
methyl 2-[4-dimethylamino-6-(2,2,2-trifluoroethoxy)-1,3,5-triazin-2-ylcarbamoylsulfamoyl]-3-methylbenzoate (DPX-66037, triflusulfuron-methyl),
oxetan-3-yl 2-[(4,6-dimethylpyrimidin-2-yl)carbamoylsulfamoyl]benzoate (CGA-277476, oxasulfuron),
methyl 4-iodo-2-[3-(4-methoxy-6-methyl-1,3,5-triazin-2-yl)ureidosulfonyl]benzoate, sodium salt (iodosulfuron-methyl-sodium),
methyl 2-[3-(4,6-dimethoxypyrimidin-2-yl)ureidosulfonyl]-4-methanesulfonylaminomethylbenzoate (mesosulfuron-methyl, WO 95/10507),
N,N-dimethyl-2-[3-(4,6-dimethoxypyrimidin-2-yl)ureidosulfonyl]-4-formylaminobenzamide (foramsulfuron, WO 95/01344),
1-(4,6-dimethoxy-1,3,5-triazin-2-yl)-3-[2-(2-methoxyethoxy)phenylsulfonyl]urea (cinosulfuron),
methyl 2-[(4-ethoxy-6-methylamino-1,3,5-triazin-2-yl)carbamoylsulfamoyl]benzoate (ethametsulfuron-methyl),
1-(4-methoxy-6-methyl-1,3,5-triazin-2-yl)-3-[2-(3,3,3-trifluoropropyl)phenylsulfonyl]urea (prosulfuron),
methyl 2-(4,6-dimethylpyrimidin-2-ylcarbamoylsulfamoyl)benzoate (sulfometuron-methyl),
1-(4-methoxy-6-trifluoromethyl-1,3,5-triazin-2-yl)-3-(2-trifluoromethylbenzenesulfonyl)urea (tritosulfuron);
(A2.2) thienylsulfonylureas, for example
1-(2-methoxycarbonylthiophen-3-yl)-3-(4-methoxy-6-methyl-1,3,5-triazin-2-yl)urea (thifensulfuron-methyl);
(A2.3) pyrazolylsulfonylureas, for example
1-(4-ethoxycarbonyl-1-methylpyrazol-5-ylsulfonyl)-3-(4,6-dimethoxypyrimidin-2-yl)urea (pyrazosulfuron-ethyl),
methyl 3-chloro-5-(4,6-dimethoxypyrimidin-2-ylcarbamoylsulfamoyl)-1-methylpyrazole-4-carboxylate (halosulfuron-methyl),
methyl 5-(4,6-dimethylpyrimidin-2-yl-carbamoylsulfamoyl)-1-(2-pyridyl)pyrazole-4-carboxylate (NC-330, s. Brighton Crop Prot. Conf. ‘Weeds’ 1991, Vol. 1, p. 45 ff.),
1-(4,6-dimethoxypyrimidin-2-yl)-3-[1-methyl-4-(2-methyl-2H-tetrazol-5-yl)pyrazol-5-yl-sulfonyl]urea (DPX-A8947, azimsulfuron);
(A2.4) sulfonediamide derivatives, for example
3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, special issue XII, 489-497 (1990));
(A2.5) pyridylsulfonylureas, for example
1-(3-N,N-dimethylaminocarbonylpyridin-2-ylsulfonyl)-3-(4,6-dimethoxypyrimidin-2-yl)-urea (nicosulfuron),
1-(3-ethylsulfonylpyridin-2-ylsulfonyl)-3-(4,6-dimethoxypyrimidin-2-yl)urea (rimsulfuron),
methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron-methyl-sodium),
3-(4,6-dimethoxypyrimidin-2-yl)-1-(3-N-methylsulfonyl-N-methylaminopyridin-2-yl)-sulfonylurea or its salts (DE-A 40 00 503 and DE-A 40 30 577),
1-(4,6-dimethoxypyrimidin-2-yl)-3-(3-trifluoromethyl-2-pyridylsulfonyl)urea (flazasulfuron),
1-(4,6-dimethoxypyrimidin-2-yl)-3-[3-(2,2,2-trifluoroethoxy)-2-pyridylsulfonyl]urea sodium salt (trifloxysulfuron-sodium);
(A2.6) alkoxyphenoxysulfonylureas, for example
3-(4,6-dimethoxypyrimidin-2-yl)-1-(2-ethoxyphenoxy)sulfonylurea or its salts (ethoxysulfuron);
(A2.7) imidazolylsulfonylureas, for example
1-(4,6-dimethoxypyrimidin-2-yl)-3-(2-ethylsulfonylimidazo[1,2-a]pyridin-3-yl)sulfonylurea (MON 37500, sulfosulfuron),
1-(2-chloroimidazo[1,2-a]pyridin-3-ylsulfonyl)-3-(4,6-dimethoxypyrimidin-2-yl)urea (imazosulfuron);
(A2.8) phenylaminosulfonylureas, for example
1-[2-(cyclopropylcarbonyl)phenylaminosulfonyl]-3-(4,6-dimethoxypyrimidin-2-yl)urea (cyclosulfamuron);
(A3) chloroacetanilides, for example
acetochlor, alachlor, butachlor, dimethachlor, dimethenamid, metazachlor, metolachlor, S-metolachlor, pethoxamid, pretilachlor, propachlor, propisochlor and thenylchlor;
(A4) thiocarbamates, for example
S-ethyl N,N-dipropylthiocarbamate (EPTC),
S-ethyl N,N-diisobutylthiocarbamate (butylate);
cycloate, dimepiperate, esprocarb, molinate, orbencarb, pebulate, prosulfocarb, thiobencarb, tiocarbazil and tri-allate;
(A5) cyclohexanedione oximes, for example
alloxydim, butroxydim, clethodim, cloproxydim, cycloxydim, protoxydim, sethoxydim, tepraloxydim and tralkoxydim;
(A6) imidazolinones, for example
imazamethabenz-methyl, imazapic, imazamox, imazapyr, imazaquin and imazethapyr;
(A7) triazolopyrimidinesulfonamide derivatives, for example
chloransulam-methyl, diclosulam, florasulam, flumetsulam, metosulam and penoxulam;
(A8) benzoylcyclohexanediones, for example
2-(2-chloro-4-methylsulfonylbenzoyl)cyclohexane-1,3-dione (SC-0051, sulcotrione),
2-(2-nitrobenzoyl)-4,4-dimethylcyclohexane-1,3-dione (EP-A 0 274 634),
2-(2-nitro-3-methylsulfonylbenzoyl)-4,4-dimethylcyclohexane-1,3-dione (WO 91/13548),
2-[4-(methylsulfonyl)-2-nitrobenzoyl-1,3-cyclohexanedione (mesotrione);
(A9) benzoylisoxazoles, for example
5-cyclopropyl-[2-(methylsulfonyl)-4-(trifluoromethyl)benzoyl]isoxazole (isoxaflutole);
(A10) benzoylpyrazoles, for example
2-[4-(2,4-dichloro-m-toluyl)-1,3-dimethylpyrazol-5-yloxy]-4′-methylacetophenone (benzofenap),
4-(2,4-dichlorobenzoyl)-1,3-dimethylpyrazol-5-yl toluene-4-sulfonate (pyrazolynate),
2-[4-(2,4-dichlorobenzoyl)-1,3-dimethylpyrazol-5-yloxy]acetophenone (pyrazoxyfen);
(A11) sulfonylaminocarbonyltriazolinones, for example
4,5-dihydro-3-methoxy-4-methyl-5-oxo-N-(2-trifluoromethoxyphenylsulfonyl)-1H-1,2,4-triazole-1-carboxamide sodium salt (flucarbazone-sodium),
methyl 2-(4,5-dihydro-4-methyl-5-oxo-3-propoxy-1H-1,2,4-triazol-1-yl)carboxamidosulfonylbenzoate sodium salt (propoxycarbazone-Na);
(A12) triazolinones, for example
4-amino-N-tert-butyl-4,5-dihydro-3-isopropyl-5-oxo-1,2,4-1H-triazole-1-carboxamide (amicarbazone),
2-(2,4-dichloro-5-prop-2-ynyloxyphenyl)-5,6,7,8-tetrahydro-1,2,4-triazolo[4,3-a]pyridin-3(2H)-one (azafenidin),
ethyl(RS)-2-chloro-3-[2-chloro-5-(4-difluoromethyl-4,5-dihydro-3-methyl-5-oxo-1H-1,2,4-triazol-1-yl)-4-fluorophenyl]propionate (carfentrazone-ethyl),
2′,4′-dichloro-5′-(4-difluoromethyl-4,5-dihydro-3-methyl-5-oxo-1H-1,2,4-triazol-1-yl)-methanesulfonanilide (sulfentrazone);
(A13) phosphinic acids and derivatives, for example
4-[hydroxy(methyl)phosphinoyl]-L-homoalanyl-L-alanyl-L-alanine (bilanafos),
DL-homoalanin-4-yl(methyl)phosphinic acid ammonium salt (glufosinate-ammonium);
(A14) glycine derivatives, for example
N-(phosphonomethyl)glycine and its salts (glyphosate and salts, for example the sodium salt or the isopropylammonium salt),
N-(phosphonomethyl)glycine trimesium salt (sulfosate);
(A15) pyrimidinyloxypyridinecarboxylic acid derivatives and pyrimidinyloxybenzoic acid derivatives, for example
benzyl 3-(4,6-dimethoxypyrimidin-2-yl)oxypyridine-2-carboxylate (EP-A 0 249 707),
methyl 3-(4,6-dimethoxypyrimidin-2-yl)oxypyridine-2-carboxylate (EP-A 0 249 707),
1-(ethoxycarbonyloxyethyl)2,6-bis[(4,6-dimethoxypyrimidin-2-yl)oxy]benzoate (EP-A 0 472 113),
2,6-bis[(4,6-dimethoxypyrimidin-2-yl)oxy]benzoic acid (bispyribac-sodium),
pyribenzoxim, pyriftalid, pyriminobac-methyl and pyrithiobac-sodium;
(A16) S—(N-aryl-N-alkylcarbamoylmethyl)dithiophosphonic acid esters, such as S—[N-(4-chlorophenyl)-N-isopropylcarbamoylmethyl]O,O-dimethyl dithiophosphate (anilophos);
(A17) triazinones, for example
3-cyclohexyl-6-dimethylamino-1-methyl-1,3,5-triazine-2,4-(1H,3H)-dione (hexazinone),
4-amino-4,5-dihydro-3-methyl-6-phenyl-1,2,4-triazin-5-one (metamitron),
4-amino-6-tert-butyl-4,5-dihydro-3-methylthio-1,2,4-triazin-5-one (metribuzin);
(A18) pyridinecarboxylic acids, for example
clopyralid, fluroxypyr, picloram and triclopyr;
(A19) pyridines, for example
dithiopyr and thiazopyr;
(A20) pyridinecarboxamides, for example
diflufenican and picolinafen;
(A21) 1,3,5-triazines, for example
ametryn, atrazine, cyanazine, dimethametrin, prometon, prometryn, propazine, simazine, symetryn, terbumeton, terbuthylazine, terbutryn and trietazine;
(A22) hydroxybenzonitriles, for example
bromoxynil (3,5-dibromo-4-hydroxybenzonitrile), bromoxynil-octanoate, bromoxynil-heptanoate, bromoxynil-octanoate/heptanoate, bromoxynil-potassium, ioxynil (4-hydroxy-3,5-di-iodobenzonitrile), ioxynil-octanoate, ioxynil-sodium,
(A23) dinitroanilides such as trifluralin and pendimethalin,
(A24) carbamates such as chlorpropham,
(A25) ureas such as metabenthiazuron, linuron and monolinuron,
(A26) nitrodiphenylethers such as oxyfluorfen,
(A27) oxydiazoles such as oxadiazon and oxadiargyl,
(A28) benzofurans such as ethofumesate,
(A29) benzamides such as isoxaben, and
(A30) bypyridylium derivatives such as paraquat dichloride.

The herbicides of groups (A1) to (A30) are known, for example, from the respective abovementioned publications and from “The Pesticide Manual”, The British Crop Protection Council, 13th Edition, 2003 (=“PM”), or the e-Pesticide Manual, Version 3.0, British Crop Protection Council 2003.

Preferred herbicides are selected from the group consisting of chloroacetic acid, chlorpropham, chlorthal-dimethyl, clopyralid, cyanamide, ethofumesate, formasulfuron, haloxyfop, haloxyfop-P, hydroxybenzonitrils (such as bromoxynil and ioxynil), isoxaben, linuron, mesosulfuron, metazachlor, methabenzthiazuron, metribuzin, monolinuron, oxadiazon, oxyfluorfen, paraquat dichloride, pendimethalin, prometryn, propachlor, propisochlor, sethoxydim, simazine, trifluralin.

Preferred plant growth regulators are selected from the group consisting of maleic hydrazide and mepiquat chloride.

Fungicidally active compounds which can be used in combination with the crop-plant-protecting compounds (I) according to the invention are preferably commercially available active compounds, for example (analogously to the herbicides, the compounds are generally referred to by their common names): 2-phenylphenol; 8-hydroxyquinoline sulfate; acibenzolar-5-methyl; actinovate; aldimorph; amidoflumet; ampropylfos; ampropylfos-potassium; andoprim; anilazine; azaconazole; azoxystrobin; benalaxyl; benodanil; benomyl; benthiavalicarb-isopropyl; benzamacril; benzamacril-isobutyl; binapacryl; biphenyl; bitertanol; blasticidin-S; boscalid; bromuconazole; bupirimate; buthiobate; butylamine; calcium polysulfide; capsimycin; captafol; captan; carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)cycloheptanol; clozylacon; cyazofamid; cyflufenamid; cymoxanil; cyproconazole; cyprodinil; cyprofuram; Dagger G; debacarb; dichlofluanid; dichlone; dichlorophen; diclocymet; diclomezine; dicloran; diethofencarb; difenoconazole; diflumetorim; dimethirimol; dimethomorph; dimoxystrobin; diniconazole; diniconazole-M; dinocap; diphenylamine; dipyrithione; ditalimfos; dithianon; dodine; drazoxolon; edifenphos; epoxiconazole; ethaboxam; ethirimol; etridiazole; famoxadone; fenamidone; fenapanil; fenarimol; fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; fluquinconazole; flurprimidol; flusilazole; flusulfamide; flutolanil; flutriafol; folpet; fosetyl-Al; fosetyl-sodium; fuberidazole; furalaxyl; furametpyr; furcarbanil; furmecyclox; guazatine; hexachlorobenzene; hexaconazole; hymexazol; imazalil; imibenconazole; iminoctadine triacetate; iminoctadine tris(albesilate); iodocarb; ipconazole; iprobenfos; iprodione; iprovalicarb; irumamycin; isoprothiolane; isovaledione; kasugamycin; kresoxim-methyl; mancozeb; maneb; meferimzone; mepanipyrim; mepronil; metalaxyl; metalaxyl-M; metconazole; methasulfocarb; methfuroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]methyl].alpha.-(methoxymethylene)benzeneacetate; methyl 2-[2-[3-(4-chlorophenyl)-1-methylallylideneaminooxymethyl]phenyl]-3-methoxyacrylate; metiram; metominostrobin; metrafenone; metsulfovax; mildiomycin; monopotassium carbonate; myclobutanil; myclozolin; nabam, N-(3-ethyl-3,5,5-trimethylcyclohexyl)-3-formylamino-2-hydroxybenzamide; N-(6-methoxy-3-pyridinyl)cyclopropanecarboxamide; N-butyl-8-(1,1-dimethylethyl)-1-oxaspiro[4.5]decan-3-amine; natamycin; nitrothal-isopropyl; noviflumuron; nuarimol; ofurace; orysastrobin; oxadixyl; oxolinic acid; oxpoconazole; oxycarboxin; oxyfenthiin; paclobutrazol; pefurazoate; penconazole; pencycuron; penthiopyrad; phosdiphen; phthalide; picobenzamid; picoxystrobin; piperalin; polyoxins; polyoxorim; probenazole; prochloraz; procymidone; propamocarb; propanosine-sodium; propiconazole; propineb; proquinazid; prothioconazole; pyraclostrobin; pyrazophos; pyrifenox; pyrimethanil; pyroquilon; pyroxyfur; pyrroInitrine; quinconazole; quinoxyfen; quintozene; silthiofam; simeconazole; sodium tetrathiocarbonate; spiroxamine; sulfur; tebuconazole; tecloftalam; tecnazene; tetcyclacis; tetraconazole; thiabendazole; thicyofen; thifluzamide; thiophanate-methyl; thiram; tiadinil; tioxymid; tolclofos-methyl; tolylfluanid; triadimefon; triadimenol; triazbutil; triazoxide; tricyclamide; tricyclazole; tridemorph; trifloxystrobin; triflumizole; triforine; triticonazole; uniconazole; validamycin A; vinclozolin; zineb; ziram; zoxamide; (2S)-N-[2-[4-[[3-(4-chlorophenyl)-2-propynyl]oxy]-3-methoxyphenyl]ethyl]-3-methyl-2-[(methylsulfonyl)amino]-butanamide; 1-(1-naphthalenyl)-1H-pyrrole-2,5-dione; 2,3,5,6-tetrachloro-4-(methylsulfonyl)pyridine; 2,4-dihydro-5-methoxy-2-methyl-4-[[[[1-[3-(trifluoromethyl)phenyl]ethylidene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxamide; 3,4,5-trichloro-2,6-pyridinedicarbonitrile; 3-[(3-bromo-6-fluoro-2-methyl-1H-indol-1-yl)sulfonyl]-N,N-dimethyl-1H-1,2,4-triazole-1-sulfonamide; copper salts and copper preparations, such as Bordeaux mixture; copper hydroxide; copper naphthenate; copper oxychloride; copper sulfate; cufraneb; copper(I) oxide; mancopper; oxine-copper;

Of particular interest are fungicides selected from the group consisting of benalaxyl, bitertanol, bromuconazol, captafol, carbendazim, carpropamid, cyazofamid, cyproconazol, diethofencarb, edifenphos, fenpropimorph, fentine, fluquinconazol, fosetyl, fluoroimide, folpet, iminoctadine, iprodionem, iprovalicarb, kasugamycin, maneb, nabam, pencycuron, prochloraz, propamocarb, propineb, pyrimethanil, sprioxamine, quintozene, tebuconazole, tolylfluanid, triadimefon, triadimenol, trifloxystrobin, zineb.

Preferred fungicides are selected from the group consisting of benalaxyl, captafol, cyazofamid, diethofencarb, fenpropimorph, fluoroimide, folpet, iminoctadine, kasugamycin, maneb, nabam, quintozene, zineb.

Pesticides against harmful animals (such as insecticidally, acaricidally and similarly active active compounds, in short “insecticides”) are, for example (analogously to the herbicides and fungicides, compounds are, if possible, referred to by their common names):

alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-5-methyl, demeton-5-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, acrinathrin, allethrin (d-cis-trans, d-trans), beta-cyfluthrin, bifenthrin, bioallethrin, bioallethrin-5-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (-1R-isomer), tralomethrin, transfluthrin, ZXI 8901, pyrethrins (pyrethrum), DDT, indoxacarb, acetamiprid, clothianidin, dinotefuran, imidacloprid, nitenpyram, nithiazine, thiacloprid, thiamethoxam, nicotine, bensultap, cartap, camphechlor, chlordane, endosulfan, gamma-HCH, HCH, heptachlor, lindane, methoxychlor spinosad, acetoprole, ethiprole, fipronil, vaniliprole, avermectin, emamectin, emamectin-benzoate, ivermectin, milbemycin, diofenolan, epofenonane, fenoxycarb, hydroprene, kinoprene, methoprene, pyriproxifen, triprene, chromafenozide, halofenozide, methoxyfenozide, tebufenozide, bistrifluron, chlofluazuron, diflubenzuron, fluazuron, flucycloxuron, flufenoxuron, hexaflumuron, lufenuron, novaluron, noviflumuron, penfluron, teflubenzuron, triflumuron, buprofezin, cyromazine, diafenthiuron, azocyclotin, cyhexatin, fenbutatin-oxide, chlorfenapyr, binapacyri, dinobuton, dinocap, DNOC, fenazaquin, fenpyroximate, pyrimidifen, pyridaben, tebufenpyrad, tolfenpyrad, hydramethylnon, dicofol, rotenone, acequinocyl, fluacrypyrim, Bacillus thuringiensis strains, spirodiclofen, spiromesifen, 3-(2,5-dimethylphenyl)-8-methoxy-2-oxo-1-azaspiro[4.5]dec-3-en-4-yl ethyl carbonate (alias: carbonic acid, 3-(2,5-dimethylphenyl)-8-methoxy-2-oxo-1-azaspiro[4.5]dec-3-en-4-yl ethyl ester, CAS-Reg.-No.: 382608-10-8) and carbonic acid, cis-3-(2,5-dimethylphenyl)-8-methoxy-2-oxo-1-azaspiro[4.5]dec-3-en-4-yl ethyl ester (CAS-Reg.-No.: 203313-25-1), flonicamid, amitraz, propargite, N2-[1,1-dimethyl-2-(methylsulfonyl)ethyl]-3-iodo-N1-[2-methyl-4-[1,2,2,2-tetrafluoro-1-(trifluoromethyl)ethyl]phenyl]-1,2-benzenedicarboxamide (CAS-Reg.-No.: 272451-65-7), thiocyclam hydrogen oxalate, thiosultap-sodium, azadirachtin, Bacillus spec., Beauveria spec., codlemone, Metarrhizium spec., Paecilomyces spec., thuringiensin, Verticillium spec., aluminum phosphide, methyl bromide, sulfuryl fluoride, cryolite, flonicamid, pymetrozine, clofentezine, etoxazole, hexythiazox, amidoflumet, benclothiaz, benzoximate, bifenazate, bromopropylate, buprofezin, chinomethionat, chlordimeform, chlorobenzilate, chloropicrin, clothiazoben, cycloprene, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin.

Insecticides which, on their own or together with herbicides, can cause damage to plants include, for example:

acetamiprid, acrinathrin, aldicarb, amitraz, acinphos-methyl, cyfluthrin, carbaryl, cypermethrin, deltamethrin, endosulfan, ethoprophos, fenamiphos, fenthion, fipronil, imidacloprid, methamidophos, methiocarb, niclosamide, oxydemeton-methyl, prothiophos, silafluofen, thiacloprid, thiodicarb, tralomethrin, triazophos, trichlorfon, triflumuron, terbufos, fonofos, phorate, chlorpyriphos, carbofuran and tefluthrin.

Of particular interest are also organophosphates, for example terbufos (Counter®), fonofos (Dyfonate®), phorate (Thimet®), chlorpyriphos (Reldan®), carbamates, such as carbofuran (Furadan®), pyrethroid insecticides, such as tefluthrin (Force®), deltamethrin (Decis®) and tralomethrin (Scout®), and other insecticidal agents having a different mechanism of action.

Preferred insecticides are selected from the group consisting of aldicarb, mecarbam, mecurous chloride, metam and terbufos.

Among the safeners mentioned, those of group (B1.1) are preferred. Also preferred are the safeners mefenpyr-diethyl (B1-1), isoxadifen-ethyl (B4-3), cloquintocet-mexyl (B5-1), benoxacor (B9-1), oxabetrinil (B11-1), fluxofenim (B11-2), naphthalic anhydride (B13-1) and the acylsulfamoylbenzamide (B17-1) defined above.

Preferred combinations are combinations of said safeners and herbicides selected from the group consisting of
(A-1) chlorpropham,
(A-2) chlorthal-dimethyl,
(A-3) clopyralid,
(A-4) cyanamide,
(A-5) ethofumesate,
(A-6) haloxyfop,
(A-7) haloxyfop-P,
(A-8) ioxynil,
(A-9) isoxaben,
(A-10) linuron,
(A-11) metazachlor,
(A-12) methabenzthiazuron,
(A-13) metribuzin,
(A-14) monolinuron,
(A-15) oxadiazon,
(A-16) oxyfluorfen,
(A-17) paraquatdichloride,
(A-18) pendimethalin,
(A-19) prometryn,
(A-20) propachlor,
(A-21) propisochlor,
(A-22) sethoxydim,
(A-23) simazine,
(A-24) trifluralin,
(A-25) chloroacetic acid,
(A-26) foramsulfuron and
(A-27) mesosulfuron and
(A-28) bromoxynil.

Particularly preferred are the following herbicide-safener combinations:
(B1-1)+(A-1), (B1-1)+(A-1), (B1-1)+(A-2), (B1-1)+(A-3), (B1-1)+(A4), (B1-1)+(A-5), (B1-1)+(A-6), (B1-1)+(A-7), (B1-1)+(A-8), (B1-1)+(A-9), (B1-1)+(A-10), (B1-1)+(A-11), (B1-1)+(A-12), (B1-1)+(A-13), (B1-1)+(A-14), (B1-1)+(A-15), (B1-1)+(A-16), (B1-1)+(A-7), (B1-1)+(A-18), (B1-1)+(A-19), (B1-1)+(A-20), (B1-1)+(A-21), (B1-1)+(A-22), (B1-1)+(A-23), (B1-1)+(A-24), (B1-1)+(A-25); (B1-1)+(A-26); (B1-1)+(A-27) and (B1-1)+(A-28);
(B4-3)+(A-1), (B4-3)+(A-2), (B4-3)+(A-3), (B4-3)+(A-4), (B4-3)+(A-5), (B4-3)+(A-6), (B4-3)+(A-7), (B4-3)+(A-8), (B4-3)+(A-9), (B4-3)+(A-10), (B4-3)+(A-11), (B4-3)+(A-12), (B4-3)+(A-13), (B4-3)+(A-14), (B4-3)+(A-15), (B4-3)+(A-16), (B4-3)+(A-7), (B4-3)+(A-18), (B4-3)+(A-19), (B4-3)+(A-20), (B4-3)+(A-21), (B4-3)+(A-22), (B4-3)+(A-23), (B4-3)+(A-24), (B4-3)+(A-25); (B4-3)+(A-26); (B4-3)+(A-27) and (B4-3)+(A-28);
(B5-1)+(A-1), (B5-1)+(A-2), (B5-1)+(A-3), (B5-1)+(A-4), (B5-1)+(A-5), (B5-1)+(A-6), (B5-1)+(A-7), (B5-1)+(A-8), (B5-1)+(A-9), (B5-1)+(A-10), (B5-1)+(A-11), (B5-1)+(A-12), (B5-1)+(A-13), (B5-1)+(A-14), (B5-1)+(A-15), (B5-1)+(A-16), (B5-1)+(A-7), (B5-1)+(A-18), (B5-1)+(A-19), (B5-1)+(A-20), (B5-1)+(A-21), (B5-1)+(A-22), (B5-1)+(A-23), (B5-1)+(A-24), (B5-1)+(A-25); (B5-1)+(A-26); (B5-1)+(A-27) and (B5-1)+(A-28);
(B9-1)+(A-1), (B9-1)+(A-2), (B9-1)+(A-3), (B9-1)+(A-4), (B9-1)+(A-5), (B9-1)+(A-6), (B9-1)+(A-7), (B9-1)+(A-8), (B9-1)+(A-9), (B9-1)+(A-10), (B9-1)+(A-11), (B9-1)+(A-12), (B9-1)+(A-13), (B9-1)+(A-14), (B9-1)+(A-15), (B9-1)+(A-16), (B9-1)+(A-7), (B9-1)+(A-18), (B9-1)+(A-19), (B9-1)+(A-20), (B9-1)+(A-21), (B9-1)+(A-22), (B9-1)+(A-23), (B9-1)+(A-24), (B9-1)+(A-25); (B9-1)+(A-26); (B9-1)+(A-27) and (B9-1)+(A-28);
(B11-1)+(A-1), (B11-1)+(A-2), (B11-1)+(A-3), (B11-1)+(A-4), (B11-1)+(A-5), (B11-1)+(A-6), (B11-1)+(A-7), (B11-1)+(A-8), (B11-1)+(A-9), (B11-1)+(A-10), (B11-1)+(A-11), (B11-1)+(A-12), (B11-1)+(A-13), (B11-1)+(A-14), (B11-1)+(A-15), (B11-1)+(A-16), (B11-1)+(A-7), (B11-1)+(A-18), (B11-1)+(A-19), (B11-1)+(A-20), (B11-1)+(A-21), (B11-1)+(A-22), (B11-1)+(A-23), (B11-1)+(A-24), (B11-1)+(A-25); (B11-1)+(A-26); (B11-1)+(A-27) and (B11-1)+(A-28);
(B11-2)+(A-1), (B11-2)+(A-2), (B11-2)+(A-3), (B11-2)+(A-4), (B11-2)+(A-5), (B11-2)+(A-6), (B11-2)+(A-7), (B11-2)+(A-8), (B11-2)+(A-9), (B11-2)+(A-10), (B11-2)+(A-11), (B11-2)+(A-12), (B11-2)+(A-13), (B11-2)+(A-14), (B11-2)+(A-15), (B11-2)+(A-16), (B11-2)+(A-7), (B11-2)+(A-18), (B11-2)+(A-19), (B11-2)+(A-20), (B11-2)+(A-21), (B11-2)+(A-22), (B11-2)+(A-23), (B11-2)+(A-24), (B11-2)+(A-25); (B11-2)+(A-26); (B11-2)+(A-27) and (B11-2)+(A-28);
(B13-1)+(A-1), (B13-1)+(A-2), (B13-1)+(A-3), (B13-1)+(A-4), (B13-1)+(A-5), (B13-1)+(A-6), (B13-1)+(A-7), (B13-1)+(A-8), (B13-1)+(A-9), (B13-1)+(A-10), (B13-1)+(A-11), (B13-1)+(A-12), (B13-1)+(A-13), (B13-1)+(A-14), (B13-1)+(A-15), (B13-1)+(A-16), (B13-1)+(A-7), (B13-1)+(A-18), (B13-1)+(A-19), (B13-1)+(A-20), (B13-1)+(A-21), (B13-1)+(A-22), (B13-1)+(A-23), (B13-1)+(A-24), (B13-1)+(A-25); (B13-1)+(A-26); (B13-1)+(A-27) and (B13-1)+(A-28);
(B17-1)+(A-1), (B17-1)+(A-2), (B17-1)+(A-3), (B17-1)+(A-4), (B17-1)+(A-5), (B17-1)+(A-6), (B17-1)+(A-7), (B17-1)+(A-8), (B17-1)+(A-9), (B17-1)+(A-10), (B17-1)+(A-11), (B17-1)+(A-12), (B17-1)+(A-13), (B17-1)+(A-14), (B17-1)+(A-15), (B17-1)+(A-16), (B17-1)+(A-7), (B17-1)+(A-18), (B17-1)+(A-19), (B17-1)+(A-20), (B17-1)+(A-21), (B17-1)+(A-22), (B17-1)+(A-23), (B17-1)+(A-24), (B17-1)+(A-25); (B17-1)+(A-26), (B17-1)+(A-27) and (B17-1)+(A-28).

The combinations of the compounds (A) or their salts and the safeners (B) can be used, for example, as such or in the form of their preparations (formulations) combined with other pesticidally active substances, such as, for example, insecticides, acaricides, nematicides, molluscicides, miticides, herbicides, fungicides, safeners, fertilizers and/or growth regulators, for example in the form of a finished formulation or tank mixes. The preferred additional active compounds are herbicides.

Also preferred according to the invention are those combinations in which one or more further active compounds of a different structure [active compounds (C)] are added, such as:

(A)+(B)+(C), wherein (C) is one or more other active compounds.

Suitable active compounds (C) which can be combined with the active compounds according to the invention in mixed formulations or in a tank mix are, for example, known active compounds, for example herbicides, insecticides and fungicides, preferably herbicides, as described already above for the compounds (A).

In individual cases, it may be advantageous to combine one or more compounds (A) with a plurality of compounds (B).

The application rate of the herbicides (A) can be varied within wide limits, the optimum amount depending on the herbicide in question, the spectrum of harmful plants and the crop plants. In general, the application rate for spray application is in the range from 0.001 g to 12 kg, preferably 1 g to 3 kg, very particularly 5 g to 2 kg of active compound (a.i.) per ha, depending on efficacy of the individual compound (A)

The amount of safener used varies according to a number of parameters including the particular safener employed, the crop to be protected, the amount and rate of herbicide applied, the soil type and climatic conditions prevailing. Also, the selection of the specific safener for use in the method of the invention, the manner in which it is to be applied and the determination of the activity which is non-phytotoxic but antidotally effective, can be readily performed in accordance with common practice in the art. The application rate of safener can vary within wide limits and is generally in the range from 0.001 g to 2 kg, preferably from 0.005 to 1 kg, more preferably from 0,005 g to 500 g of safener (a.i.) per hectare. For seed treatment the use is, for example, from 0.001 g to 1 kg a.i. safener per kg seed, preferably 0.05 g to 500 g a.i. safener per kg seed, in particular 0.1 g to 250 g a.i. safener per kg seed.

If solutions of safener (B) are used for seed dressing and the seeds or seedlings are wetted with the solutions, the suitable concentration is generally in the range from 0.1 to 100000 ppm, preferably 1 to 10 000 ppm, more preferably from 100 to 1000 ppm, based on the weight. The amounts and weight ratios required for a successful treatment can be determined by simple preliminary experiments.

The pesticidally active compounds and the safeners can be applied together (as finished formulation or by the tank-mix method) or sequentially in any order. The weight ratio pesticide (A): safener (B) can vary within wide limits and is, for example, in the range from 1:200 to 200:1, preferably from 1:100 to 100:1, in particular from 1:20 to 20:1, most preferably from 1:10 to 10:1, preferably when applied by the spraying technique in pre-emergence or the post-emergence application. If the safener is used in seed-treatment the ratio of pesticide to safener may vary within wide limits also, and is, for example, in the range from 1000:1 to 1:1, preferably from 500:1 to 10:1, most preferably from 200:1 to 10:1. The amounts of pesticidally active compound and safener which are optimal in each case depend on the active compound (A) and the safener (B) in question and on the type of crops to be treated, and they can be determined in each case by appropriate preliminary experiments.

Depending on their properties, the safeners may be used for pre-treating the seed of the crop plant (seed dressing) or the seedlings, plantlets, bulbs or somatic embryos or be incorporated into the seed furrow prior to sowing. In the pretreatment of seedlings it is possible, for example, to spray the roots or the entire seedling with a solution of the safener or to dip them into such a solution. The use of one or more pesticides can then be carried out by the pre-emergence or post-emergence method. Pesticides such as fungicides or insecticides can often also be applied by seed treatment and can thus also be combined with the safener in the seed treatment.

Alternatively, it is possible to apply the safeners together with the pesticides, before or after emergence of the plants. Pre-emergence treatment includes both the treatment of the area under cultivation prior to sowing and the treatment of the areas under cultivation where the crops have been sown but not yet emerged. Preferred is also a sequential procedure, where the treatment with safener is carried out first followed, preferably closely, by application of the pesticide.

In general, simultaneous application of safener and pesticide in the form of tank mixes or finish formulations is preferred. Also preferred is the seed treatment with the safener (B), followed by sowing of the crop and application of the pesticide (A), preferrably in case of herbicides, during pre-emergence or post-emergence of the crop. Also preferred is the seed treatment with a combination of the safener (B) and a pesticide (A) selected from fungicides and pesticides against harmful animals.

Accordingly, the invention also provides a method for protecting crop plants against phytotoxic side effects of a pesticide (A), which method comprises the application of an amount, acting as an antidote, of one or more safeners (B) before, after or simultaneously with the pesticide (A) to the plants, parts of plants, plant seeds or the area under cultivation.

The pesticide-safener combinations according to the invention (i.e. the herbicidal compositions) have excellent pesticidal activity against a broad spectrum of economically important harmful organisms.

In case the pesticide (A) is a herbicide the herbicidal effects of the combinations aginst weeds are similar to those of the herbicides (A) when used alone at comparable application rates.

Owing to their herbicidal and plant growth-regulatory properties, the combinations can be employed for controlling harmful plants in known crops or in still to be developed genetically engineered plants. Transgenic plants generally have particularly advantageous properties, for example resistance to certain pesticides, above all certain herbicides, resistance to plant diseases or causative organisms of plant diseases, such as certain insects or microorganisms such as fungi, bacteria or viruses. Other particular properties relate, for example, to the quantity, quality, storage-stability, composition and to specific ingredients of the harvested product. Thus, transgenic plants having an increased starch content or a modified quality of the starch or those having a different fatty acid composition of the harvested product are known.

The combinations according to the invention are preferably employed in economically important transgenic crops of useful and ornamental plants, for example of leeks and onions.

The invention also provides the use of the pesticidal compositions comprising combinations of (A)+(B) for controlling harmful organisms, preferably in plant crops.

The active compound combinations according to the invention can be present both as mixed formulations of the two components, if appropriate with other active compounds, additives and/or customary formulation auxiliaries, which are then applied in a customary manner diluted with water, or be prepared as so-called tank mixes by joint dilution of the separately formulated or partially separately formulated components with water.

The compounds (A) and (B) or their combinations can be formulated in various ways depending on the prevailing biological and/or chemico-physical parameters. Examples of suitable formulation options are: wettable powders (WP), emulsifiable concentrates (EC), aqueous solutions (SL), emulsions (EW), such as oil-in-water and water-in-oil emulsions, sprayable solutions or emulsions, oil- or water-based dispersions, suspoemulsions, dusts (DP), seed-dressing compositions, granules for broadcasting and soil application, or water-dispersible granules (WG), ULV formulations, micro-capsules or waxes.

The individual formulation types are known in principle and are described, for example, in Winnacker-Kuchler, “Chemische Technologie” [Chemical Technology], Volume 7, C. HanserVerlag Munich, 4th. Edition 1986; van Valkenburg, “Pesticides Formulations”, Marcel Dekker, N.Y., 1973; K. Martens, “Spray Drying Handbook”, 3rd Ed. 1979, G. Goodwin Ltd. London. The necessary formulation auxiliaries, such as inert materials, surfactants, solvents and other additives, are likewise known and are described, for example, in Watkins, “Handbook of Insecticide Dust Diluents and Carriers”, 2nd Ed., Darland Books, Caldwell N.J., H. v. Olphen, “Introduction to Clay Colloid Chemistry”; 2nd Ed., J. Wiley & Sons, N.Y.; C. Marsden, “Solvents Guide”; 2nd Ed., Interscience, N.Y. 1950; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte” [Surface-active ethylene oxide adducts], Wiss. Verlagsgesellschoft, Stuttgart 1976; Winnacker-Kuchler, “Chemische Technologie” [Chemical Technology], Volume 7, C. Hanser Verlag Munich, 4th Edition 1986.

Based on these formulations it is also possible to produce combinations with other pesticidally active substances, such as other herbicides, fungicides or insecticides, and also with safeners, fertilizers and/or growth regulators, for example in the form of a ready-mix or tank mix.

Wettable powders are preparations which are uniformly dispersible in water and which contain, in addition to the active compound and as well as a diluent or inert substance, surfactants of ionic or nonionic type (wetting agents, dispersants), for example polyethoxylated alkyl phenols, polyethoxylated fatty alcohols, polyethoxylated fatty amines, alkanesulfonates, alkylbenzenesulfonates, sodium ligninsulfonate, sodium 2,2′-dinaphthylmethane-6,6′-disulfonate, sodium dibutyinaphthalene-sulfonate or else sodium oleoylmethyltaurinate.

Emulsifiable concentrates are prepared by dissolving the active compound in an organic solvent, for example butanol, cyclohexanone, dimethylformamide, xylene or else relatively high-boiling aromatic compounds or hydrocarbons with the addition of one or more surfactants of ionic or nonionic type (emulsifiers). Examples of emulsifiers which can be used are calcium alkylarylsulfonates, such as Ca dodecylbenzenesulfonate, or nonionic emulsifiers, such as fatty acid polyglycol esters, alkylaryl polyglycol ethers, fatty alcohol polyglycol ethers, propylene oxide-ethylene oxide condensation products, alkyl polyethers, sorbitan fatty acid esters, polyoxyethylene sorbitan fatty acid esters or polyoxyethylene sorbitan esters.

Dusts are obtained by grinding the active compound with finely divided solid substances, for example talc, natural clays, such as kaolin, bentonite and pyrophyllite, or diatomaceous earth.

Granules can be prepared either by spraying the active compound onto adsorptive, granulated inert material or by applying active-compound concentrates to the surface of carriers such as sand, kaolinites or granulated inert material, by means of adhesive binders, for example polyvinyl alcohol, sodium polyacrylate or else mineral oils. Suitable active compounds can also be granulated in the manner which is customary for the preparation of fertilizer granules, if desired as a mixture with fertilizers. Water-dispersible granules are generally prepared by processes such as spray-drying, fluidized-bed granulation, disk granulation, mixing using high-speed mixers, and extrusion without solid inert material.

The agrochemical formulations generally contain from 0.1 to 99% by weight, in particular from 2 to 95% by weight, of active compounds of types A and/or B, the following concentrations being customary, depending on the type of formulations: In wettable powders the concentration of active compound is, for example, from about 10 to 95% by weight, the remainder to 100% by weight consisting of customary formulation constituents. In emulsifiable concentrates the concentration of active compound can be, for example, from 5 to 80% by weight.

Formulations in the form of dusts usually contain from 5 to 20% by weight of active compound, while sprayable solutions contain from about 0.2 to 25% by weight of active compound.

In the case of granules, such as dispersible granules, the content of active compound depends partly on whether the active compound is in liquid or solid form and on which granulation auxiliaries and fillers that are used. In water-dispersible granules the content is generally between 10 and 90% by weight.

In addition, said formulations of active compound may comprise the tackifiers, wetting agents, dispersants, emulsifiers, preservatives, antifreeze agents and solvents, fillers, colorants and carriers, antifoams, evaporation inhibitors, pH and viscosity regulators, thickeners and/or fertilizers which are customary in each case.

For use, the formulations, which are in commercially available form, are, if appropriate, diluted in a customary manner, for example using water in the case of wettable powders, emulsifiable concentrates, dispersions and water-dispersible granules. Preparations in the form of dusts, soil granules, granules for spreading and sprayable solutions are conventionally not diluted any further with other inert substances prior to use.

The pesticidal compounds can be applied to the plants, parts of the plants, seeds of the plants or the area under cultivation (tilled soil), preferably to the green plants and parts of the plants and, if desired, additionally to the tilled soil.

A possible use is the joint application of the active compounds in the form of tank mixes, where the concentrated formulations of the individual active substances, in the form of their optimal formulations, are mixed jointly with water in the tank, and the resulting spray mixture is applied. Also preferred is the application of the safener by seed treatment, such as seed coating or seed dressing. The treated seed of useful plants can then be used to grow the respective crop, and the crop is then safened against damage otherwise occurring after application of pesticides to the crop plants.

A joint pesticidal formulation of the combination according to the invention of the active compounds (A) and (B) has the advantage that it can be applied more easily because the amounts of the components have already been adjusted to one another in the correct ratio. Moreover, the auxiliaries of the formulation can be selected to suit each other in the best possible way, while a tank mix of various formulations may result in undesirable combinations of auxiliaries.

Another object of the invention are thus novel compositions containing (A) and (B).

When the safeners (B) are applied as a seed treatment they can be applied by, but not limited to, the seed application technologies that are commonly used within the seed industry, or a combination thereof, as outlined in the book “Enhancing Seed Performance” pp. 255-372, Sheffield Academic Press, Sheffield, UK, 419 pp. ISBN 0-8493-9749-9, subsection “Seed Technology and its Biological, ed. Michael Black and J. Derek Bewley, Sheffield Academic Press, Sheffield, UK, 419 pp. ISBN 0-8493-9749-9, especially chapter 8 by Peter Halmer, pp. 257-286. These seed applications technologies are:
Applications directly to the seed using formulations such as dry powders, solutions, slurried wettable or water-dispersible powders, or flowable concentrates (emulsion or micro-encapsulated formulations)
Soaking the seeds in a (aqueous) solution containing the safener (B)
Film coating in which the safener formulation is pre mixed in aqueous suspension with a binder, adjuvants, pigments and opacifiers, and sprayed onto the moving seeds in a filmcoating equipment
Pelleting and encrustment in which the safener formulations are mixed with or (film) coated on top of the pellet encrustment. Pelleting and encrustment involve the same processing steps, comprising build-up, drying, and size-grading. Seed contained in revolving pans or drums of various designs is wetted and a blend of powdered materials is progressively added, along with more water or glue, until the desired weight or size increase is reached. Encrustments and pellets distinguish themselves by the amount of inert material stuck to the seeds. In encrusted seeds the shape of the seed is still distinguishable and the major purpose of the encrustment is weight increase. Pelleted seeds are typically oval or round and the original seed size is no longer distinguishable. The typical purpose of pellets is weight increase and a uniform pellets size. Both encrusted and pelleted seeds are used for enhanced sowing characteristics.

Seed application of safeners can be done on conventional seeds or seeds that have been enhanced by seed enhancement technologies such as steeping and priming (“Enhancing Seed Performance” pp. 255-372, Sheffield Academic Press, Sheffield, UK, 419 pp. ISBN 0-8493-9749-9, subsection “Seed Technology and its Biological Basis”, ed. Michael Black and J. Derek Bewley, especially chapter 9 by Miller MacDonald pp. 287-325). Or the safeners can be applied to artificial seeds, such as somatic embryos (see “Enhancing Seed Performance” mentioned above, subsection “Seed Technology and its Biological Basis”, chapter 10 by David R. Cyr pp. 326-372).

A further object of the invention are thus seeds or seedlings treated with compounds (B) or combinations of (A) and (B), e.g. prepared by the techniques mentioned such as the seed coating or dressing techniques, wherein the seeds or seedlings are selected from seeds of those plants as defined above, preferably leek and onion.

### A. GENERAL FORMULATION EXAMPLES

a) A dust is obtained by mixing 10 parts by weight of an active compound/active compound mixture and 90 parts by weight of talc as inert substance and comminuting the mixture in a hammer mill.

b) A wettable powder which is readily dispersible in water is obtained by mixing 25 parts by weight of an active compound/active compound mixture, 64 parts by weight of kaolin-containing quartz as inert substance, 10 parts by weight of potassium lignosulfonate and 1 part by weight of sodium oleoylmethyltaurinate as wetting agent and dispersant, and grinding the mixture in a pinned-disk mill.

c) A dispersion concentrate which is readily dispersible in water is obtained by mixing 20 parts by weight of an active compound/active compound mixture with 6 parts by weight of alkylphenol polyglycol ether (®Triton X 207), 3 parts by weight of isotridecanol polyglycol ether (8 EO) and 71 parts by weight of paraffinic mineral oil (boiling range for example approximately 255 to 277° C.) and grinding the mixture in a ball mill to a fineness of below 5 microns.

d) An emulsifiable concentrate is obtained from 15 parts by weight of an active compound/active compound mixture, 75 parts by weight of cyclohexanone as solvent and 10 parts by weight of ethoxylated nonylphenol as emulsifier.

e) Water-dispersible granules are obtained by mixing
75 parts by weight of an active compound/active compound mixture,
10 parts by weight of calcium lignosulfonate,
5 parts by weight of sodium lauryl sulfate,
3 parts by weight of polyvinyl alcohol and
7 parts by weight of kaolin,
   grinding the mixture in a pinned-disk mill and granulating the powder in a fluidized bed by spraying on water as granulation liquid.

f) Water-dispersible granules are also obtained by homogenizing and precomminuting, in a colloid mill,
25 parts by weight of an active compound/active compound mixture,
5 parts by weight of sodium 2,2′-dinaphthylmethane-6,6′-disulfonate,
2 parts by weight of sodium oleoylmethyltaurinate,
1 part by weight of polyvinyl alcohol,
17 parts by weight of calcium carbonate and
50 parts by weight of water,
   subsequently grinding the mixture in a bead mill and atomizing and drying the resulting suspension in a spray tower by means of a single-substance nozzle.

### B. BIOLOGICAL EXAMPLES

The following non-limiting Examples illustrate the invention.

1. Herbicide and Safener Pre-Emergence Application by the Tank Mix Method

Seeds of various vegetable crop plants and weed species were sown in sandy loam soil in round plastic pots of a diameter of 13 cm and covered with a layer of sandy loam of a thickness of about 1 cm. Herbicides and safeners in the form of liquid (for example emulsion concentrates) or dry (for example water-dispersible powders) formulations were diluted with deionized water to the required concentration and applied to the surface of the soil with a spray bar using a water application rate of 300 liters per hectare.

The pots were placed in a greenhouse under favorable growth conditions. Visual scoring of the herbicidal action was carried out four weeks after the herbicide application. Evaluation was carried out on a percentage basis by comparison with untreated control plants (0%=no noticeable effect compared with the untreated plant, 100%=treated plant dies).

2. Post-Emergence Application of Herbicide and Safener by the Tank Mix Method.

Seeds of leek plants were sown in sandy loam soil in round plastic pots of a diameter of 7 cm and covered with a layer of sandy loam of a thickness of about 0.2 cm. The pots were placed in a greenhouse under favorable growth conditions for until the plants had reached the 2-leaves growth stage. Then, a herbicide or—in a parallel experiment—a tank-mix of the herbicide and a safener (using same basic formulation in each case) was applied to the green parts of the plants and the uncovered part of the soil surface with a spray bar using a water application rate of 300 liters per hectare.

The pots were placed in a greenhouse under favorable growth conditions. Visual scoring of the herbicidal action was carried out 21 or 40 days after treatment with the herbicide or the tank-mix, respectively. Evaluation was carried out on a percentage basis by comparison with untreated control plants (0%=no noticeable effect compared with the untreated plant, 100%=treated plant dies). The results are summarized in the table 1 below.

TABLE 1
Post-emergence application of leek

| | Application | | | |
|---|---|---|---|---|
| Active | rate | Scoring | Damage to leek (in %) | |
| ingredients | [g a.i./ha] | DAT | variety Kenton | variety Harston |
| H1 | 600 | 40 | 55% | 40% |
| H1 + S1 | 600 + 100 | 40 | 10% | 10% |
| H1 + S2 | 600 + 100 | 40 | 10% | 10% |
| H2 | 250 | 40 | 20% | 20% |
| H2 + S1 | 250 + 100 | 40 | 0% | 0% |
| H2 + S2 | 250 + 100 | 40 | 0% | 0% |
| H3 | 50 | 40 | 45% | 50% |
| H3 + S1 | 50 + 100 | 40 | 0% | 0% |
| H4 | 50 | 21 | 50% | 50% |
| H4 + S1 | 50 + 100 | 21 | 0% | 10% |

Abbreviations in Table 1:
H1 = ioxynil
H2 = linuron
H3 = mesosulfuron (oder mesosulfuron-methyl)
H4 = foramsulfuron
S1 = mefenpyr-diethyl
S2 = isoxadifen-ethyl
DAT = days after treatment
a.i. = active ingredient (calculated on 100% active ingredient)

3. Post-Emergence Application of Herbicide and Safener by the Tank Mix Method.

Seeds of onion plants were sown in sandy loam soil in round plastic pots of a diameter of 7 cm and covered with a layer of sandy loam of a thickness of about 0.2 cm. The pots were placed in a greenhouse under favorable growth conditions for until the plants had reached the 2-leaves growth stage. Then, a herbicide or—in a parallel experiment—a tank-mix of the herbicide and a safener (using same basic formulation in each case) was applied to the green parts of the plants and the uncovered part of the soil surface with a spray bar using a water application rate of 300 liters per hectare.

The pots were placed in a greenhouse under favorable growth conditions. Visual scoring of the herbicidal action was carried out 21 or 40 days after treatment with the herbicide or the tank-mix, respectively. Evaluation was carried out on a percentage basis by comparison with untreated control plants (0%=no noticeable effect compared with the untreated plant, 100%=treated plant dies). The results are summarized in the table 2 below.

TABLE 2
Post-emergence application of onion

| | | | Damage to onion (in %) | |
|---|---|---|---|---|
| Active | Application rate | Scoring | variety Blanco | variety |
| ingredients | [g a.i/ha] | DAT | Duro | Brioso |
| H1 | 600 | 21 | 55% | 45% |
| H1 + S1 | 600 + 100 | 40 | 20% | 0% |
| H2 | 250 | 40 | 100% | 30% |
| H2 + S2 | 250 + 100 | 40 | 40% | 10% |
| H3 | 50 | 40 | 70% | 50% |
| H3 + S1 | 50 + 100 | 40 | — | 20% |
| H3 + S2 | 50 + 100 | 40 | 30% | — |
| H4 | 50 | 21 | 10% | 30% |
| H4 + S1 | 50 + 100 | 21 | 0% | 10% |

Abbreviations in Table 2:
H1 = ioxynil
H2 = linuron
H3 = mesosulfuron-methyl
H4 = foramsulfuron
S1 = mefenpyr-diethyl
S2 = isoxadifen-ethyl
DAT = days after treatment
a.i. = active ingredient (calculated on 100% active ingredient)

4. Seed Treatment of Leek with Safener Followed by Early Post-Emergence Treatment with Herbicide
Materials and Methods

Leek (allium porrum var. Parton) seeds were put in an erlenmeyer flask with a spinning stirring magnet. A droplet of binder (glue) was added and distributed evenly amongst the seeds. Subsequently, a small amount of encrustment powder (X % mefenpyr-diethyl+[100−X]% inert filler material) was added and mixed through the seeds using the stirring magnet. A droplet of binder was added again and this procedure was repeated until all encrustment powder was stuck to the seeds. Seeds were dried subsequently.

The differently-treated seeds were sown in trays. After 9 days, the seedlings were sprayed with 4.0 g/l ioxynil using an atomizer. A dosage of 3 ml per tray was applied, equalizing 1200 g.a.i./hectare. At 6 days after spraying the number of collapsed seedlings was counted.

Results

At 6 days after application, more than 50% of the control-treated seedlings were collapsed, whereas the mefenpyr-treated seedlings showed significantly less damage.

The results are summarized in Table 3. Similar results were found with another leek variety (i.e. Shelton).

TABLE 3
Seed treatment of leek with safener, early post-emergence
application of herbicide (encrustment method)

| Active | Application rate | Application time | Damage to leek |
|---|---|---|---|
| ingredients | [g a.i./ha] | after seeding | (in %) 6 DAT |
| H | 1200 | 9 days | 52% |
| ST + H | ST1 + 1200 | 9 days | 26% |
| ST + H | ST2 + 1200 | 9 days | 2% |

Abbreviations in Table 3:
H = herbicide ioxynil
ST = seed treatment with mefenpyr-diethyl
ST1 = seed treatment of leek seed with 0.4 g a.i./kg mefenpyr-diethyl
ST2 = seed treatment of leek seed with 2 g a.i./kg mefenpyr-diethyl
DAT = days after treatment

5. Seed Treatment of Onion with Safener Followed by Early Post-Emergence Treatment with Herbicide
Materials and Methods

Onion (Allium cepa var. Brioso) seeds were encrusted in a commercial seed coating machine. Approximately 1 ml of binder was added. Subsequently, a small amount of encrustment powder (X % Naphthalic Anhydride+[100−X]% inert filler material) was added. Binder was added again and this procedure was repeated until all encrustment powder was stuck to the seeds. Seeds were dried subsequently.

The differently-treated seeds were sown in trays. After 9 days, the seedlings were sprayed with 1.0 g/l ioxynil using an atomizer. A dosage of 3 ml per tray was applied, equalizing 300 g.a.i./hectare. At 3 days after spraying the number of collapsed seedlings was counted.

Results

Severe symptoms were observed after 3 days already. Almost 60% of the control-treated seedlings had collapsed, whereas all naphthalic anhydride-treated seedlings showed significantly less damage (see Table 4).

TABLE 4
Seed treatment of onion with safener, early post-emergence
application of herbicide (encrustment with rotostat)

| Active | Application rate | Application time | Damage to onion |
|---|---|---|---|
| ingredients | [g a.i./ha] | after seeding | (in %) 3 DAT |
| H | 300 | 9 days | 57% |
| ST + H | ST1 + 300 | 9 days | 39% |
| ST + H | ST2 + 300 | 9 days | 26% |

Abbreviations in Table 4:
H = herbicide ioxynil
ST = seed treatment
ST1 = seed treatment of onion seed with 10 g a.i./kg naphthalic anhydride
ST2 = seed treatment of onion seedwith 50 g a.i./kg naphthalic anhydride
DAT = days after treatment

6. Seed Treatment of Leek with Safener Followed by Early Post-Emergence Treatment with Herbicide
Materials and Methods

Leek (allium porrum var. Shelton) seeds were coated in a commercial seed coating machine. Gradually, binder solution with X g of mefenpyr-diethyl was added. Seeds were dried subsequently.

The differently-treated seeds were sown in the field using commercial sowing equipment. After 25 days, the seedlings were sprayed with a standard formulation of ioxynil (®Totril) at an application rate of 112 g a.i./ha ioxynil. At 15 days after spraying the number of collapsed seedlings was counted.

Results

The percentage collapsed control-treated plants in the field was approximately 6% at 15 days after herbicide application (see Table 5). Application of the highest rate of mefenpyr-diethyl (2.0 g.a.i./kg) significantly reduced the amount of damage (see Table 5).

TABLE 5
Seed treatment of leek with safener, early post-emergence
application of herbicide (seed coating with rotostat system)

| Active | Application rate | Application time | Damage to leek |
|---|---|---|---|
| ingredients | [g a.i./ha] | after seeding | (in %) 15 DAT |
| H | 112 | 25 days | 6% |
| ST + H | ST1 + 112 | 25 days | 6% |
| ST + H | ST2 + 112 | 25 days | 4.7% |
| ST + H | ST3 + 112 | 25 days | 1.2% |

Abbreviations in Table 5:
H = herbicide ioxynil
ST = seed treatment with mefenpyr-diethyl
ST1 = seed treatment of leek seed with 0.4 g a.i./kg mefenpyr-diethyl
ST2 = seed treatment of leek seed with 1.0 g a.i./kg mefenpyr-diethyl
ST3 = seed treatment of leek seed with 2.0 g a.i./kg mefenpyr-diethyl
DAT = days after treatment

7. Seed Treatment of Leek with Safener Followed by Early Post-Emergence Treatment with Herbicide

Leek seeds (allium porrum, var. Shelton or Parton) were treated with safener, sown, treated with a herbicide and evaluated as described in Example 6 with the difference that the herbicide is prometryn. Details of application rate, application time and results are set forth in table 6 below.

TABLE 6
Mefenpyr safening Prometryn damage in leek

| | | Application | | Damage |
|---|---|---|---|---|
| | Safener | rate | application time | to seedling |
| | [g a.i./kg | of herbicide H5 | after seeding | (% collapsed) |
| Variety | seed] | [g a.i./ha] | [days] | at 6 DAT |
| Shelton | 0 | 750 | 10 | 11 |
| Shelton | 1 | 750 | 10 | 2 |
| Shelton | 2 | 750 | 10 | 1 |
| Parton | 0 | 750 | 10 | 9 |
| Parton | 1 | 750 | 10 | 3 |
| Parton | 2 | 750 | 10 | 1 |

Abbreviations in Table 6:
H5 = herbicide prometryn (used as standard formulation ® Gesagard)
Safener = mefenpyr-diethyl
DAT = days after treatment

8. Seed Treatment of Leek with Safener Followed by Early Post-Emergence Treatment with Herbicide

Leek seeds (allium porrum, var. Shelton) were treated with safener, sown, treated with a herbicide and evaluated as described in Example 6 with the difference that the herbicide is prometryn. Details of application rate, application time and results are set forth in table 7 below.

TABLE 7
Fluxofenim safening loxynil damage in leek

| | | Application | | Damage |
|---|---|---|---|---|
| | Safener | rate | application time | to seedling |
| | [g a.i./kg | of herbicide H | after seeding | (% collapsed) |
| Variety | seed] | [g a.i./ha] | [days] | at 5 DAT |
| Shelton | 0 | 112 | 10 | 16 |
| Shelton | 1 | 112 | 10 | 10 |
| Shelton | 2 | 112 | 10 | 6 |

Abbreviations in Table 7:
H = herbicide ioxynil (used as standard formulation ® Totril)
Safener = fluxofenim
DAT = days after treatment

9. Seed Treatment of Leek with Safener Followed by Early Post-Emergence Treatment with Herbicide

Leek seeds (allium porrum, var. Shelton) were treated with safener, sown, treated with a herbicide and evaluated as described in Example 6 with the difference that the herbicide is prometryn. Details of application rate, application time and results are set forth in table 8 below.

TABLE 8
Oxabetrinil safening loxynil damage in leek

| | | Application | | Damage |
|---|---|---|---|---|
| | Safener | rate | application time | to seedling |
| | [g a.i./kg | of herbicide H | after seeding | (% collapsed) |
| Variety | seed] | [g a.i./ha] | [days] | at 7 DAT |
| Shelton | 0 | 112 | 10 | 45 |
| Shelton | 1 | 112 | 10 | 25 |
| Shelton | 2 | 112 | 10 | 27 |
| Shelton | 4 | 112 | 10 | 13 |

Abbreviations in Table 8:
H = herbicide ioxynil (used as standard formulation ® Totril)
Safener = oxabetrinil
DAT = days after treatment

10. Seed Treatment of Onion with Safener Followed by Early Post-Emergence Treatment with Herbicide

Onion (Allium cepa var. Diamante) were treated with safener, sown, treated with a herbicide and evaluated as described in Example 5 with the difference that the herbicide is oxyfluorfen and the safener is mefenpyr-diethyl. Details of application rate, application time and results are set forth in table 9 below.

TABLE 9
Mefenpyr safening oxyfluorfen damage in onion

| | | Application | application | Damage |
|---|---|---|---|---|
| | Safener | rate | time | to seedling |
| | [g a.i./kg | of herbicide H6 | after seeding | (% collapsed) |
| Variety | seed] | [g a.i./ha] | [days] | at 5 DAT |
| Diamante | 0 | 7.5 | 9 | 83 |
| Diamante | 2 | 7.5 | 9 | 64 |
| Diamante | 4 | 7.5 | 9 | 49 |
| Diamante | 8 | 7.5 | 9 | 39 |

Abbreviations in Table 9:
H6 = herbicide oxyfluorfen (used as standard formulation ® Goal)
Safener = mefenpyr-diethyl
DAT = days after treatment

11. Seed Treatment of Onion with Safener Followed by Early Post-Emergence Treatment with Herbicide

Onion (Allium cepa var. Diamante) were treated with safener, sown, treated with a herbicide and evaluated as described in Example 5 with the difference that the herbicide is bromoxynil-octanoate and the safener is benoxacor. Details of application rate, application time and results are set forth in table 10 below.

TABLE 10
Benoxacor safening bromoxynil damage in onion

| | | Application | application | Damage |
|---|---|---|---|---|
| | Safener | rate | time | to seedling |
| | [g a.i./kg | of herbicide H7 | after seeding | (% collapsed) |
| Variety | seed] | [g a.i./ha] | [days] | at 5 DAT |
| Diamante | 0 | 25 | 10 | 19 |
| Diamante | 1 | 25 | 10 | 7 |
| Diamante | 2 | 25 | 10 | 0 |

Abbreviations in Table 10:
H7 = herbicide bromoxynil-octanoate (used as standard formulation ® Buctril)
Safener = benoxacor
DAT = days after treatment

What is claimed is:

1. A method for reducing or avoiding phytotoxic side-effects of a pesticide (A) in useful plants selected from the plant order Liliiflorae, which comprises application of an effective amount of a compound (B) as a safener before, after or simultaneously with the application of the pesticide (A) to the plants, part of the plants, plant seeds or the area under cultivation, wherein
(A) is one or more pesticides or agriculturally acceptable salts thereof, and
(B) is one or more safeners selected from the group consisting of
(B1) compounds of the dichlorophenylpyrazoline-3-carboxylic acid type,
(B2) dichlorophenylpyrazolecarboxylic acid derivatives,
(B3) compounds of the triazolecarboxylic acids type,
(B4) compounds of the 5-benzyl- or 5-phenyl-2-isoxazoline-3-carboxylic acid type or the 5,5-diphenyl-2-isoxazoline-3-carboxylic acid,
(B5) compounds of the 8-quinolinoxyacetic acid type,
(B6) compounds of the (5-chloro-8-quinolinoxy)malonic acid type,
(B7) active substances of the phenoxyacetic or phenoxypropionic acid derivatives type or of the aromatic carboxylic acids type,
(B8) active substances of the pyrimidines type,
(B9) active substances of the dichloroacetamides type,
(B10) active substances of the dichloroacetone derivatives type,
(B11) active substances of the oxyimino compounds type,
(B12) active substances of the thiazolecarboxylic ester type,
(B13) active substances of the naphthalenedicarboxylic acid derivatives type,
(B14) active substances of the chromanacetic acid derivatives type,
(B15) active substances which, in addition to a herbicidal action against harmful plants, also exhibit a safener action in connection with crop plants,
(B16) N-acylsulfonamides of the formula (S3) and their salts 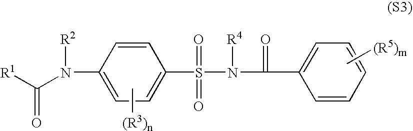
(B17) acylsulfamoylbenzamides of the formula (S4), if appropriate also in salt form, 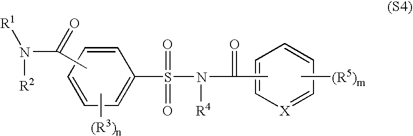
(B18) dietholate, and
(B19) mephenate,
or salts of the compounds mentioned.

2. The method as claimed in claim 1, characterized by a compound (B) being one or more safeners selected from the group consisting of mefenpyr-diethyl, fenchlorazol-ethyl, isoxadifen-ethyl, cloquintocet-mexyl, fenclorim, dichlormid, R-29148, benoxacor, PPG-1292, DK-24, AD-67, MON 4660, diclonon, BAS145138, LAB145138, furilazol, MG 191, oxabetrinil, fluxofenim, cyometrinil, flurazole, naphthalic anhydride, CL 304415, dimepiperate, daimuron, cumyluron, methoxyphenone, safeners of the group of acylsulfamoylbenzamides, CSB, dietholate and mephenate.

3. The method as claimed in claim 1, characterized by a compound (B) being one or more safeners selected from the group consisting of mefenpyr-diethyl, fenchlorazol-ethyl, isoxadifen-ethyl, cloquintocet-mexyl, fenclorim, dichlormid, benoxacor, AD-67, furilazole, oxabetrinil, fluxofenim, cyometrinil, flurazole, naphthalic anhydride, dimepiperate, daimuron, cumyluron, methoxyphenone and safeners of the group of acylsulfamoylbenzamides.

4. The method as claimed in any of claim 1, characterized by the compound (A) being selected from the group consisting of chloroacetic acid, chlorpropham, chlorthaldimethyl, clopyralid, cyanamide, ethofumesate, foramsulfuron, haloxyfop, haloxyfop-P, hydroxybenzonitrils, isoxaben, linuron, mesosulfuron, metazachlor, methabenzthiazuron, metribuzin, monolinuron, oxadiazon, oxyfluorfen, paraquat dichloride, pendimethalin, prometryn, propachlor, propisochlor, sethoxydim, simazine and trifluralin.

5. The method as claimed in claim 1, characterized by the crop plant being selected from the group consisting of plant families Liliaceae, Amaryllidaceae, Iridaceae and Juncadeae.

6. The method as claimed in claim 1, characterized by the crop plant being leek.

7. The method as claimed in claim 1, characterized by a safener selected from the group consisting of mefenpyr-diethyl, isoxadifen-ethyl, cloquintocet-mexyl, naphthalic anhydride, benoxacor, oxabetrinil, fluxofenim and safeners of the group of acylsulfamoylbenzamides.

8. The method as claimed in claim 1, characterized by the ratio of pesticide (A) and safener (B) being in a weight ratio of from 200:1 to 1:200.

9. The method as claimed in claim 1, characterized by seed treatment of the crop seed with safener (B).

10. The method as claimed in claim 9, characterized by the ratio of pesticide (A) and safener (B) being in a weight ratio of from 1000:1 to 1:1,

11. A method as claimed in claim 1 characterized by the crop plant being onion.

12. A method for selective control of harmful organisms in useful plants selected from the plant order Liliiflorae which comprises applying a pesticidally effective amount of one or more pesticides (A) and an crop-safening effective amount of one or more safeners (B) before, after or simultaneous with the application of pesticide (A) to the plants, parts of plants, plant seeds or the area under cultivation, pesticide (A) and safener (B) and plants being defined as in claim 1.

13. Seed of useful plants selected from the plant order Liliiflorae, characterized by the seed being treated with an effective crop-safening amount of one or more safeners (B) as defined in claim 1.

14. Seed as claimed in claim 13, characterized by the seed being treated according to a technique selected from seed dressing, seed coating, seed soaking, seed pelleting and seed encrusment.

15. Seed as claimed in claim 13, characterized by the crop plant being leek.

16. Seed as claimed in claim 13, characterized by the crop plant being onion.

17. Process for preparing seeds as defined in claim 13, characterized in that seeds of useful plants selected from the plant order Liliiflorae are treated with an effective crop-safening amount of one or more safeners (B).
